(19) United States
(12) Patent Application Publication
(10) Pub. No.: US 2026/0214116 A1
(43) Pub. Date: Jul. 23, 2026

(54) REAL-TIME DETECTION AND MITIGATION OF CACHE POISONING ON DNS RESOLVERS

(71) Applicant: Palo Alto Networks, Inc., Santa Clara, CA (US)

(72) Inventors: Shu Wang, San Jose, CA (US); Ruian Duan, Santa Clara, CA (US); Daiping Liu, Sunnyvale, CA (US); Fan Fei, Pleasanton, CA (US); Tingxiang Zhu, Santa Clara, CA (US); Tong Zhao, Santa Clara, CA (US)

(21) Appl. No.: 19/035,348

(22) Filed: Jan. 23, 2025

(51) Int. Cl. H04L 9/40

(52) U.S. Cl. CPC H04L 63/1441

(57) ABSTRACT

The present application discloses a method, system, and computer system for detecting or preventing domain name system (DNS) cache poisoning. The method includes (i) obtaining a set of DNS responses for a particular domain, wherein each DNS response comprises a destination port and a transaction identifier, (ii) determining that at least a subset of the set of DNS responses are invalid DNS responses based at least in part on the destination port and the transaction identifier, (iii) detecting a DNS cache poisoning attempt in response to determining that a number of invalid DNS responses satisfies a predefined threshold, and (iv) performing an action in response to detecting the DNS cache poisoning attempt.

### BACKGROUND OF THE INVENTION

The Domain Name System (DNS) is a critical component of the internet infrastructure, translating human-readable domain names (e.g., www.example.com) into IP addresses that computers use to identify each other on the network. DNS cache poisoning is a cyberattack targeting the Domain Name System (DNS), a critical component of internet infrastructure responsible for translating human-readable domain names into IP addresses. In a DNS cache poisoning attack, malicious actors exploit vulnerabilities in DNS resolvers to inject false information into the resolver's cache. Once poisoned, the resolver directs users to malicious websites or incorrect destinations instead of legitimate ones, often leading to phishing attempts, malware distribution, or denial of service.

### BRIEF DESCRIPTION OF THE DRAWINGS

Various embodiments of the invention are disclosed in the following detailed description and the accompanying drawings.

FIG. 1 is a block diagram of an environment for providing a security service to a network according to various embodiments.

FIG. 2 is a flow diagram of a DNS cache poisoning attempt.

FIG. 3 is a flow diagram of a DNS cache poisoning attempt.

FIG. 4 is a block diagram of a DNS security service for handling DNS queries and detecting or mitigating DNS cache poisoning according to various embodiments.

FIG. 5 is a flow diagram of a method for handling a DNS query according to various embodiments.

FIG. 6 is a flow diagram of a method for detecting a brute force DNS cache poisoning attempt according to various embodiments.

FIG. 7 is a flow diagram of a method for determining a representative DNS response for a DNS query according to various embodiments.

FIG. 8 is a flow diagram of a method for detecting DNS cache poisoning according to various embodiments.

FIG. 9 is a flow diagram of a method for collecting DNS responses in connection with detecting a brute force DNS cache poisoning according to various embodiments.

FIG. 10 is a flow diagram of a method for detecting a brute force DNS cache poisoning attempt according to various embodiments.

FIG. 11 is a flow diagram of a method for determining whether a DNS response is valid according to various embodiments.

FIG. 12 is a flow diagram of a method for obtaining a DNS response for a DNS query according to various embodiments.

FIG. 13 is a flow diagram of a method for obtaining a DNS response for a DNS query according to various embodiments.

FIG. 14 is a flow diagram of a method for determining a representative DNS response for a DNS query according to various embodiments.

FIG. 15 is a flow diagram of a method for handling a DNS query based on a real time domain classifications according to various embodiments.

FIG. 16 is a flow diagram of a method for obtaining a real time domain classification according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall such as a next generation firewall. As another example, a security entity may be implemented as a router, a switch, a DNS resolver, a computer, a tablet, a laptop, a smartphone, etc. Various other devices may be implemented as a security entity. As another example, a security entity may be implemented as an application running on a device, such as an anti-malware application.

As used herein, a model includes a machine learning model and/or a deep learning model. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc. In some embodiments, a model is a large language model.

DNS resolving is the process by which a Domain Name System (DNS) translates a human-readable domain name, such as “example.com,” into a machine-readable IP address, such as “192.0.2.1,” which is necessary for connecting to web servers and other internet resources. This process is essential for enabling seamless navigation of the internet, as it allows users to access websites and services without needing to remember complex numerical IP addresses.

The process begins when a user enters a domain name into a web browser or an application makes a DNS query. This DNS query is sent to a DNS resolver, often managed by the user's Internet Service Provider (ISP) or a third-party DNS service provider. The DNS resolver acts as an intermediary, responsible for locating the correct IP address corresponding to the requested domain name. If the DNS resolver has the requested domain's information cached locally (e.g., in a DNS cache), it returns the IP address immediately, reducing latency and avoiding unnecessary queries to upstream servers.

If the DNS resolver does not have the requested information cached, it initiates a series of queries to other DNS servers to retrieve the necessary data. First, the resolver queries a root DNS server, which provides a referral to the appropriate top-level domain (TLD) server based on the domain's extension, such as “.com” or “.org.” The resolver then contacts the TLD server, which provides a referral to the authoritative DNS server for the specific domain. The authoritative server is the final source of truth, containing the records that map the domain name to its IP address. Once the resolver receives this information, it returns the IP address to the client, enabling the user's device to establish a connection with the desired server.

To optimize performance and reduce query load, DNS resolvers cache responses for a specified time period determined by the Time-to-Live (TTL) value in the DNS record. This caching mechanism minimizes repeated queries for the same domain name and improves the speed of DNS resolution. However, this reliance on caching also introduces vulnerabilities, such as the potential for DNS cache poisoning, where malicious actors manipulate cached records to redirect users to malicious destinations.

DNS caching is a mechanism used to store the results of DNS queries temporarily, allowing subsequent requests for the same domain name to be resolved more quickly. This process improves the efficiency of DNS resolution, reduces latency for users, and decreases the overall load on upstream DNS servers. By keeping previously retrieved DNS records locally for a specified duration, DNS caching minimizes redundant queries and conserves network resources.

When a DNS resolver or client performs a query, the result is cached for a period defined by the Time-to-Live (TTL) value in the DNS record. The TTL specifies how long the record can be stored in the cache before it is considered outdated. For example, if a TTL is set to 3600 seconds (1 hour), the resolver or client can reuse the cached record for any subsequent requests within that hour, avoiding the need to query authoritative servers repeatedly. This caching can occur at multiple levels, including the client device, the DNS resolver (often provided by an ISP or third-party service), or even within a web browser.

The caching process works by storing various types of DNS records, such as A records (which map domain names to IPv4 addresses), AAAA records (for IPv6 addresses), and CNAME records (for domain aliases), in a structured format (e.g., in a DNS cache, such as a local cache stored at, or accessible by, a cloud DNS resolving service). When a new DNS query is made, the system first checks the DNS cache for an existing, valid record. If a matching record is found and has not yet expired, the cached result is returned immediately, significantly reducing response time. If no valid record exists in the cache, the DNS query is forwarded to the appropriate DNS servers, and the result is cached after being retrieved.

DNS caching can be implemented at several levels within the DNS infrastructure. At the client level, operating systems and applications can maintain a local DNS cache to handle queries quickly without relying on external resources. At the DNS resolver level, recursive DNS resolvers cache responses from upstream servers to serve multiple clients efficiently. Additionally, some content delivery networks (CDNs) and large-scale web services maintain their own DNS caching systems to ensure faster access to their domains.

Although DNS caching provides significant performance benefits, it can also introduce security and accuracy challenges. Cached records that are not frequently updated may lead to stale or incorrect responses if the original DNS data changes. Furthermore, the caching mechanism is vulnerable to DNS cache poisoning attacks, where malicious actors manipulate cached data to redirect users to fraudulent or malicious websites. To mitigate these risks, related art systems often implement security measures such as cache purging, validation mechanisms like DNSSEC, and careful management of TTL values to balance performance and accuracy.

Attackers typically carry out DNS cache poisoning by sending spoofed DNS responses that appear to originate from legitimate authoritative DNS servers. To succeed, they need to predict or brute force critical identifiers, such as the transaction ID and source port number of an active DNS query. By matching these identifiers, the spoofed response is accepted by the resolver as valid, and the fraudulent IP address is cached for future queries. Subsequent users relying on the poisoned resolver are unknowingly directed to the malicious address, perpetuating the attack.

Conventional techniques for detecting or preventing DNS cache poisoning involve a combination of basic validation measures and enhanced security protocols. Many related art systems implement source port randomization and transaction ID randomization to make it more difficult for attackers to predict the required identifiers. Some DNS resolvers incorporate query response validation mechanisms, such as DNS Security Extensions (DNSSEC), which use cryptographic signatures to verify the authenticity of DNS responses. DNSSEC ensures that DNS data has not been tampered with during transmission and originates from a legitimate source.

Despite these advancements, related art systems face limitations. Attackers continuously develop more sophisticated methods to bypass basic validation measures, such as leveraging brute force attacks to overwhelm randomization efforts. Although DNSSEC provides robust authentication, it is not universally deployed across DNS infrastructure due to implementation complexity and compatibility concerns. Additionally, many traditional systems are reactive, relying on detection mechanisms that respond to poisoning attempts only after they occur, leaving the DNS resolver vulnerable during the initial stages of an attack.

Various embodiments aims to address these gaps by introducing proactive and adaptive security mechanisms that not only detect and respond to DNS cache poisoning attempts but also prevent them from succeeding in the first place. By implementing one or more of real-time domain classification, dynamic policy enforcement, and ensemble-based DNS resolution techniques, the system provides a comprehensive solution to safeguard DNS resolvers against evolving threats. This DNS cache poisoning detection and/or mitigation technique represents a significant advancement over existing technologies, enhancing the resilience and reliability of DNS infrastructure.

Various embodiments provide a system, method, and/or device for determining a manner for resolving a DNS query based on an ensemble of DNS responses. The system, method, and/or device prevent (or otherwise mitigate) DNS cache poisoning by querying a plurality of DNS resolvers and determining an address for resolving the DNS query based on a set of DNS responses from the plurality of DNS resolvers. The method includes (i) receiving a DNS query, (ii) determining a set of DNS requests to send to a set of DNS resolvers, the set of DNS resolvers comprising a plurality of different DNS resolvers, (iii) for each DNS request in the set of DNS requests, sending a particular DNS request to a corresponding DNS resolver from the set of DNS resolvers, (iv) receiving a set of DNS responses from at least a plurality of DNS resolvers from the set of DNS resolvers, (v) determining an address for the domain associated with the DNS query based at least in part on the set of DNS responses, and (vi) providing the address for the domain associated with the DNS query.

Various embodiments provide a system, method, and/or device for determining a manner for detecting, preventing, or otherwise mitigating DNS cache poisoning. The method includes: (i) obtaining a set of DNS responses for a particular domain, wherein each DNS response comprises a destination port and a transaction identifier, (ii) determining that at least a subset of the set of DNS responses are invalid DNS responses based at least in part on the destination port and the transaction identifier, (iii) detecting a DNS cache poisoning attempt in response to determining that a number of invalid DNS responses satisfies a predefined threshold, and (iv) performing an action in response to detecting the DNS cache poisoning attempt.

Various embodiments provide a system, method, and/or device for determining a manner for mitigating DNS cache poisoning. The method includes: (i) receiving a DNS query; (ii) extracting a domain from the DNS query; (iii) performing a lookup in a domain classification cache for the extracted domain, (iv) determine whether the domain classification cache comprises an indication that the extracted domain is classified as malicious, (v) in response to determining that the domain classification cache comprises the indication that the extracted domain is classified as malicious, determining that the extracted domain is malicious, and (vi) performing an active measure based on at least in part on a determination that the extracted domain is malicious. The active measure may include one or more of: (a) dropping the DNS query, (b) sinkholing the DNS query, (c) providing an alert to a user such as a network administrator or a user of the endpoint from which the DNS query was initiated.

Various embodiments provide a system, method, and/or device for determining a manner for mitigating DNS cache poisoning. The method includes: (i) receiving a DNS query; (ii) extracting a domain from the DNS query; (iii) mitigating a DNS cache poisoning based at least in part on dropping the DNS query in response to a real-time detection that the domain extracted from the DNS query is malicious. The domain extracted from the DNS query may be determined to be malicious in response to determining that the system (e.g., a DNS resolving service, a DNS resolver, etc.) comprises a mapping of identifiers to malicious domains that comprises an identifier for the extracted domain. The identifiers may be the domain name, a hash or signature generated based on a domain attribute (e.g., the domain name, etc.), etc.

According to various embodiments, the system detects and/or prevents DNS cache poisoning by enhancing the security and reliability of DNS resolvers. DNS cache poisoning is a significant security vulnerability where attackers inject malicious data into a DNS resolver's cache, redirecting users to malicious sites or disrupting network services. The system, process, or service according to various embodiments can be implemented as part of a DNS resolver or as a security service, which may operate within the network or as a cloud-based solution. In some embodiments, the system, service, or process is implemented at a client system, such as in the case that the client stores a local DNS cache (e.g., when the client's browser caches the address information for accessed domains, etc.).

In some embodiments, the system is configured to identify (e.g., detect) and respond to DNS queries associated with malicious domains. Upon receiving a DNS request, the system can determine the domain's classification by leveraging real-time security services and applying pre-defined security policies based on the domain classification. For example, the system can query allowlists (e.g., whitelists of domains deemed to be benign or non-malicious) or denylists (e.g., blacklists of domains deemed, or previously classified as, malicious, such as within a predefined period of time). Allowlists and denylists are regularly updated to ensure the domain classifications are accurate and up-to-date. As another example, the system can query a classifier (e.g., a real time classifier, such as a machine learning model) for a real time domain classification. The classifier may generate the domain classification based on one or more attributes or characteristics associated with the DNS record, the domain, or the corresponding webpage. The classifier may be implemented locally at the system or exposed to the system, such as via a cloud security service. Based on these classifications, the system can take active measures such as blocking queries, sinkholing them to a secure address, or alerting clients or administrators about potential threats. If the domain is deemed benign, the system permits the query to be resolved normally, returning the correct response to the client.

In some embodiments, the system implements mechanisms to detect and mitigate DNS cache poisoning attacks. For instance, it monitors for brute force attempts aimed at guessing source IP addresses (or source ports) and transaction IDs to inject spoofed responses into the cache of the DNS resolver's (e.g., the system or a resolver for which the system provides a DNS security service). By tracking the number of invalid DNS responses for a domain within a specified timeframe (e.g., a predefined and configurable period of time), the system can identify potential brute force attacks. Upon detection, the system can take various countermeasures, such as purging suspicious cache entries, preventing new entries for a predefined period, or notifying network administrators of potentially compromised cache data. These measures ensure that malicious entries are not stored or propagated within the network.

In some embodiments, the system implements an ensemble approach to enhance DNS resolution security. When resolving a DNS query, the system (e.g., a DNS resolver or DNS resolving service) can distribute the request across multiple DNS resolvers located in different regions or jurisdictions. By analyzing the responses from this ensemble, the system can determine the most reliable and legitimate address for the domain in question (e.g., the domain associated with the DNS query being resolved). For example, the system selects the address that appears most frequently among the responses, reducing the risk of relying on potentially spoofed or malicious DNS data. As another example, the system selects the address that appears in the majority of the responses from the plurality of different DNS resolvers (e.g., the DNS sub-resolvers).

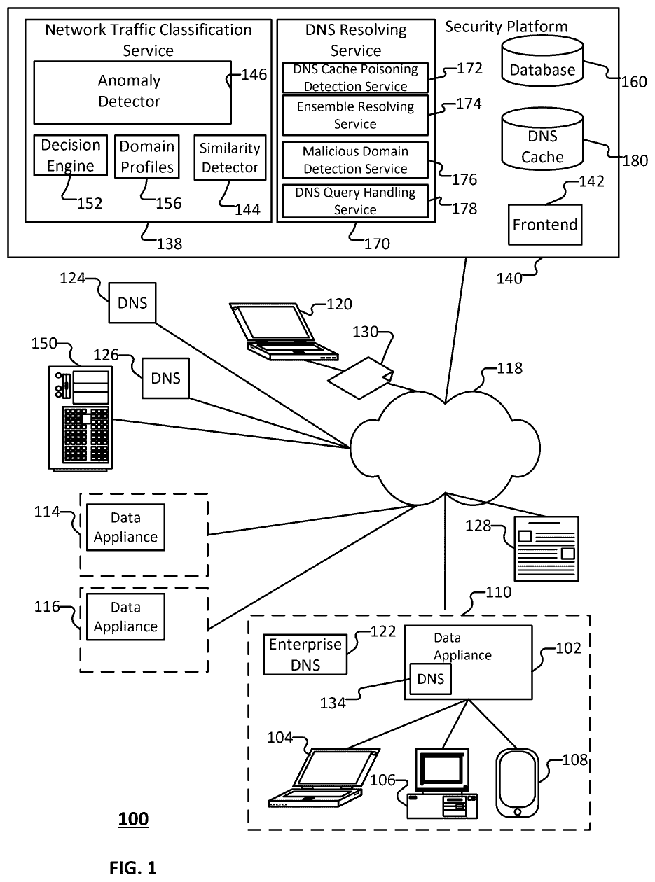

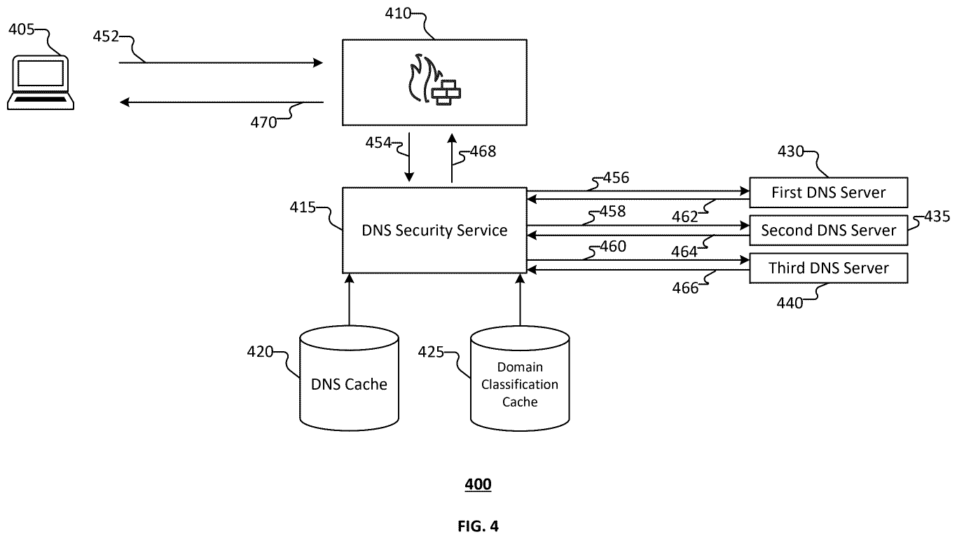

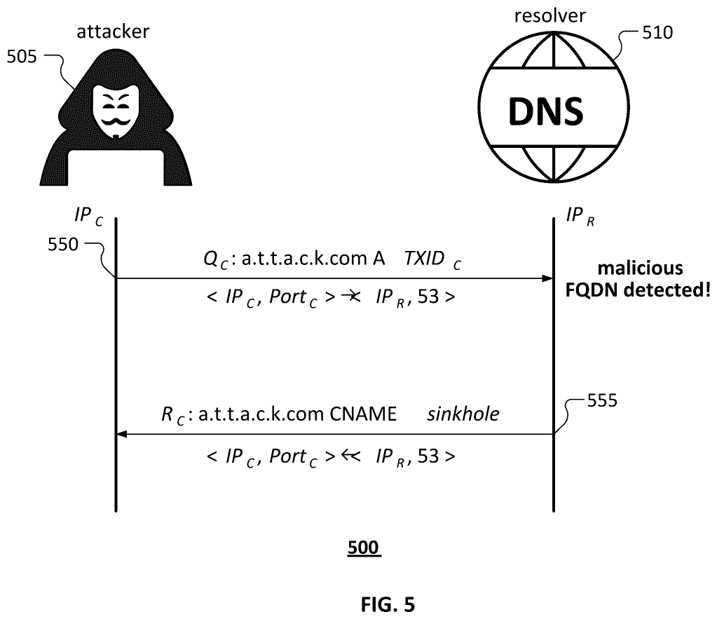

FIG. 1 is a block diagram of an environment for providing a security service to a network according to various embodiments. In some embodiments, system 100 implements at least part of system 400 of FIG. 4. System 100 can implement one or more of processes 500-1600 of FIGS. 5-16.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively blocking or sinkholing traffic, such as traffic to malicious domains, DNS hijacked domains, stockpiled domains, or squatting domains, or such as traffic for certain applications (e.g., SaaS applications). In some embodiments, data appliance 102 is also configured to enforce policies with respect to traffic that stays within (or from coming into) enterprise network 110. In some embodiments, data appliance 102 is a network edge device. For example, data appliance 102 can implement ION device functionality, security services (e.g., firewall functionality), etc.

Techniques described herein can be used in conjunction with a variety of platforms (e.g., desktops, mobile devices, gaming platforms, embedded systems, etc.) and/or a variety of types of applications (e.g., Android . ask files, iOS applications, Windows PE files, Adobe Acrobat PDF files, Microsoft Windows PE installers, etc.). In the example environment shown in FIG. 1, client devices 104-108 are endpoints, such as a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including resolving DNS queries, providing DNS resolving security services, classifying domains (e.g., predicting whether a domain is a malicious domain, etc.), classifying DNS response records (e.g., predicting whether a domain IP pair in a DNS response is a DNS hijacked record, etc.), classifying network traffic, classifying DNS traffic, providing a mapping of signatures to certain domains or DNS records (e.g., a DNS record for which a predicted likelihood that the record is a DNS hijacked record exceeds a predefined likelihood threshold, etc. a mapping of domains or DNS records to domain or DNS record data (e.g., domain certificates, pen's data, active DNS data, WHOIS data, etc.), performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacked record, detecting squatting domains, detecting a DNS cache poisoning attack (e.g., an attempt or a DNS cache entry stored based on an effective DNS cache poisoning attack), providing a list of signatures of known exploits (e.g., malicious input strings, malicious files, malicious domains, etc.) to data appliances, such as data appliance 102 as part of a subscription, detecting exploits such as malicious input strings, malicious files, DNS hijacked records or malicious domains (e.g., an on-demand detection, or periodical-based updates to a mapping of domains or DNS records to indications of whether the domains or DNS records are malicious or benign), providing a likelihood that DNS traffic (e.g., a domain or DNS record comprised in the DNS traffic) is malicious or benign, providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign), etc.

In some embodiments, DNS security services are implemented at data appliance 102. As an example, data appliance 102 can store a classifier for performing domain classification (e.g., malicious domain classification) such as in real time/contemporaneous with the handling of network traffic (e.g., DNS traffic). The classifier may be trained and/or updated by another system or service, such as by security platform 140. For example, security platform 140 can push an update to the classifier for local use by data appliance 102. As another example, data appliance 102 can store a DNS cache for use to quickly resolve DNS queries intercepted at data appliance 10. Data appliance 102 can implement the DNS cache poisoning detection and/or mitigation techniques described herein. As another example, data appliance 102 can locally store a domain classification (e.g., a maliciousness classification) for a set of domains or DNS records, such as for historical domains, popular domains, and/or other domains of interest to the network administrators. The domain classifications can be stored in a mapping of domains or domain signatures (or other domain identifiers) to domain classifications (e.g., an indication that a particular domain is malicious, an indication that a particular domain is benign or non-malicious, etc.). For example, the domain classifications may be stored as a denylist and/or an allowlist. The domain classifications (e.g., a denylist) can be updated by security platform 140 and pushed to data appliance 102.

In some embodiments, DNS security services is implemented by one or more servers, such as a cloud service. Examples of the DNS security services provided include a DNS traffic classification (e.g., a DNS record classification, a domain classification, etc.), a DNS cache poisoning detection, a DNS cache poisoning mitigation, a DNS resolving service, etc. Various other types of DNS security services may be implemented. As an example, security platform 140 performs the DNS security services. As another example, security platform 140 (e.g., DNS resolving service 170) can perform an offline classification, such as based on historical network traffic, for example, DNS traffic obtained from DNS traffic logs (e.g., DNS traffic logs stored locally at security entities or reported by the security entities to security platform). Security platform 140 can perform a real-time classification (e.g., contemporaneous with the interception/handling of the DNS traffic, etc.), such as based on receiving a query from an inline security entity (e.g., data appliance 102) for a classification.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware Six, Citrix eServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises/implements network traffic classification service 138 and/or DNS resolving service 170. Security platform 140 may include various other services/modules, such as a malicious file detector, a malicious traffic detector, a parked domain detector, an application classifier or other traffic classifier, etc.

Network traffic classification service 138 is used in connection with analyzing network traffic (e.g., websites, domains, sample files, etc. pertaining to the network traffic) and/or automatically detecting malicious network traffic.

DNS resolving service 170 is used in connection with detecting and/or preventing or mitigating against DNS cache poisoning attacks. DNS resolving service 170 can be implemented to store historical DNS records (e.g., DNS records received when processing previous DNS queries) in a DNS cache that is local to, or quickly accessible by, DNS resolving service 170. DNS resolving service 170 manages the DNS cache, detects when a DNS poisoning attack is attempted (or has been performed) and appropriately cleans up the DNS cache in response to detecting the DNS cache poisoning. DNS resolving service 170 may also be used in connection with resolving DNS queries, such as to determine a DNS response (e.g., a representative NDS response) based on an ensemble of DNS responses received from a plurality of different DNS resolvers (e.g., DNS sub-resolvers).

In response to a security entity intercepting DNS traffic, the security entity may forward DNS queries to DNS resolving service 170 for resolving. In some implementations, the security entity stores a local DNS cache that is used to quickly (e.g., immediately) resolve intercepted DNS queries. In response to receiving a DNS query from a security entity for resolving, DNS resolving service 170 can query a local DNS cache (e.g., DNS cache 180) for a DNS record matching the DNS query. If the local DNS cache stores a DNS record matching the DNS query, DNS resolving service 170 can provide (e.g., return) the address information to the security entity. If the local DNS cache does not store a matching DNS record, DNS resolving service 170 can resolve the DNS query.

In some embodiments, before resolving the query, DNS resolving service 170 obtains (e.g., determines) a real time domain classification, such as to determine whether the domain associated with the DNS query is malicious. DNS resolving service 170 can query a real time classifier, such as a classifier that is local to DNS resolving service 170 or that can be queried for a contemporaneous classification. The classifier may be a model, such as a machine learning model that predicts whether a domain is malicious based on one or more attributes associated with the domain, the DNS record, pDNS data, the webpage data, the registrar data, the registrant data, etc. Additionally, or alternatively, DNS resolving service 170 can query a mapping of domains to domain classifications, such as an allowlist, a denylist, etc. In response to determining that the domain is malicious, DNS resolving service 170 can enforce a security policy with respect to the DNS query. For example, DNS resolving service 170 can drop or sinkhole the DNS query (e.g., not further process or resolve the DNS query). Conversely, in response to determining that the domain is benign or non-malicious (or is not subject to a domain classification indicating that the domain is malicious), DNS resolving service 170 proceeds to resolve the DNS query.

In some embodiments, DNS resolving service 170 resolves queries (e.g., DNS queries forwarded by a security entity) according to conventional resolving techniques, namely querying a root DNS server, querying a TLD server, and/or querying an authoritative server, etc. In some embodiments, DNS resolving service 170 resolves queries based on an ensemble technique. DNS resolving service 170 sends (e.g., forwards) the DNS query to a plurality of different DNS resolvers, receives a plurality of DNS responses from the plurality of different DNS resolvers (e.g., the DNS sub-resolvers), and determines (e.g., generates), based at least in part on an ensemble of the DNS responses, a representative DNS response for the DNS query being processed. The different DNS resolvers may be DNS sub-resolvers that each perform the DNS resolving according to conventional techniques. For example, each DNS sub-resolver queries a root DNS server, a TLD server, and/or an authoritative server, etc.

In some embodiments, DNS resolving service 170 manages a DNS cache. The managing the DNS cache includes detecting DNS cache poisoning attempts and ensuring that the DNS cache is not subject to the DNS cache poisoning.

DNS resolving service 170 may be configured to detect brute force DNS cache poisoning attempts in which an attacker sends to the DNS resolving service 170 (or the DNS resolver that stores records in the DNS cache) a large number of spoofed DNS responses with different critical identifiers of a DNS query, such as the transaction ID and source port number of an active DNS query. For example, the attackers attempt to predict the combination of the critical identifiers for a DNS query being processed by DNS resolving service 170 (or the DNS resolver that stores records in the DNS cache). DNS resolving service 170 collects DNS responses for a particular domain and correlates the DNS responses to detect the brute force DNS cache poisoning attempts. For example, DNS resolving service 170 obtains the DNS responses for the particular domain that were collected (e.g., received) within a predefined period of time (e.g., the previous 1 second, 2 seconds, 5 seconds, or such other configurable or predefined time), and performs a DNS cache poisoning detection based on the obtained DNS responses. If DNS resolving service 170 determines that a threshold number of the obtained DNS responses are invalid responses, DNS resolving service 170 determines that the DNS responses correspond to a DNS cache poisoning attack (e.g., that the DNS cache poisoning attack is being performed). In response to determining that the DNS cache poisoning attack is performed with respect to the particular domain, DNS resolving service 170 can perform an active measure. Examples of active measures include alerting a network administrator, alerting a domain owner or administrator of the domain subject to the attack, updating the DNS cache to remove, purge, or otherwise quarantine the entry (e.g., the DNS record) for the particular domain, etc. Various other active measures may be implemented.

In some embodiments, DNS resolving service 170 comprises one or more of DNS cache poisoning detection service 172, ensemble resolving service 174, malicious domain detection service 176, and/or DNS query handling service 178.

DNS resolving service 170 provides DNS cache poisoning detection or other DNS security services for a particular network. In connection with providing such services, DNS resolving service 170 can manage a DNS cache, such as DNS cache 180 that is local to security platform 140.

DNS resolving service 170 uses DNS cache poisoning detection service 172 to detect DNS cache poisoning attacks. DNS cache poisoning detection service 172 may detect the DNS cache poisoning attacks in real time (e.g., as the attack is occurring) or post-attack based on historical DNS traffic information. In some embodiments, DNS cache poisoning detection service 172 detects brute force DNS cache poisoning attacks. DNS cache poisoning detection service 172 can detect the DNS cache poisoning attacks based on a set of DNS responses for a particular domain. For example, DNS cache poisoning detection service 172 correlates received DNS responses for a particular domain and analyzes the DNS responses to determine whether the combination of the DNS responses is indicative of a DNS cache poisoning attack. The DNS cache poisoning detection may be based on analyzing a set of DNS responses that are collected for a particular domain within a predefined time period.

The predefined time period may be configurable such as by a network or security service administrator, for example, to update the sensitivity of the detector. Examples of the predefined time period include (i) less than 5 seconds, (ii) one second, (iii) two seconds. Various other time periods/intervals may be implemented.

DNS cache poisoning detection service 172 can also implement a predefined invalid DNS response threshold in connection with detecting DNS cache poisoning attacks. The predefined invalid DNS response threshold may be configurable such as by a network or security service administrator, for example, to update the sensitivity of the detector. Examples of the predefined invalid DNS response threshold include (i) greater than or equal to 50, (ii) greater than or equal to 100, etc. Various other predefined invalid DNS response thresholds may be implemented.

DNS cache poisoning detection service 172 can use the predefined time period and the invalid DNS response threshold to detect DNS cache poisoning attacks. For example, DNS cache poisoning detection service 172 collects DNS responses for a particular domain over the predefined period of time (e.g., the last two seconds). DNS cache poisoning detection service 172 determines whether the collected DNS responses satisfies the predefined invalid DNS response threshold. For example, for each of at least a subset of the collected DNS responses for the particular domain, DNS cache poisoning detection service 172 determines whether the particular DNS response is invalid. DNS cache poisoning detection service 172 determines whether the number of invalid DNS responses from among the collected DNS responses satisfies (e.g., exceeds, or is greater than or equal to, etc.) the predefined invalid DNS response threshold. In response to determining that the number of invalid DNS responses from among the collected DNS responses satisfies (e.g., exceeds) the predefined invalid DNS response threshold, DNS cache poisoning detection service 172 determines that a DNS cache poisoning attempt is performed with respect to the particular domain. If DNS cache poisoning detection service 172 determines that the DNS cache poisoning attempt is performed with respect to the particular domain, DNS cache poisoning detection service 172 implements an active measure, such as enforcing a predefined security policy Examples of active measures defined by the predefined security policy include alerting a network or DNS security service administrator, removing/purging/quarantining a cached DNS record for the particular domain, update updating DNS cache to obtain a legitimate DNS record for the particular domain such as by using an ensemble of DNS sub-resolvers, etc.

In some embodiments, DNS cache poisoning detection service 172 determines whether a particular DNS response is valid/invalid based at least in part on information comprised in the DNS response and information comprised in an existing DNS query for the domain indicated in the DNS response. For example, DNS cache poisoning detection service 172 compares information (e.g., critical identifiers) between the existing DNS query and received DNS response and determines that the DNS response is invalid if the information comprised in the DNS response does not match the information in the corresponding existing DNS query. DNS cache poisoning detection service 172 can extract a destination address (e.g., a destination port) and a transaction identifier from the DNS response to be evaluated (e.g., for which the system is to determine whether the DNS response is valid). Similarly, DNS cache poisoning detection service 172 obtains the source address (e.g., source port) and transaction identifier extracted from the existing DNS query for the particular domain. If DNS cache poisoning detection service 172 determines that the destination address matches (e.g., is the same as) the source address and that the transaction identifiers match (e.g., the transaction identifier from the DNS response is the same as the transaction identifier from the DNS query), DNS cache poisoning detection service 172 determines the DNS response to be valid (or at least not invalid). Conversely, DNS cache poisoning detection service 172 determines the DNS response to be invalid if either or both of the following are satisfied (i) the destination address does not match the source address, and/or (ii) the transaction identifier from the DNS response does not match the transaction identifier from the existing DNS query for the particular domain.

DNS resolving service 170 uses ensemble resolving service 174 to determine a DNS record for a particular domain, such as to provide the appropriate DNS response for a DNS query. Ensemble resolving service 174 determines the appropriate DNS record for a particular domain based at least in part on querying an ensemble of DNS resolvers (e.g., a set of DNS sub-resolvers). For example, in response to receiving a DNS query (e.g., from an inline security entity, etc.), ensemble resolving service 174 queries a set of DNS resolvers (e.g., forwards the DNS query to the set of DNS resolvers) and obtains at set of DNS responses for the set of DNS resolvers. ensemble resolving service 174 determines a representative DNS response for the DNS query (e.g., the appropriate/legitimate DNS record for the domain). In some embodiments, ensemble resolving service 174 determines the representative DNS response to be the DNS response (e.g., DNS record) that most frequently appears in the set of DNS responses obtained from the set of DNS resolvers for the particular DNS query. In some embodiments, ensemble resolving service 174 determines the representative DNS response to be the DNS response for which a predefined DNS record threshold number of DNS responses have been received from the set of DNS resolvers for the particular DNS query. In some embodiments, ensemble resolving service 174 determines the representative DNS response to be the DNS response corresponding to a plurality of DNS responses of the set of DNS responses received from the set of DNS resolvers.

In some embodiments, DNS resolving service 170 uses ensemble resolving service 174 to update a DNS record stored in a DNS cache upon lapsing (or within a predefined time period of the expected lapsing) of a DNS record for a particular domain. Ensemble resolving service 174 thus ensures that the DNS cache stores a legitimate DNS record for the particular domain (e.g., to prevent a DNS cache poisoning).

DNS resolving service 170 uses malicious domain detection service 176 to detect DNS queries for malicious domains. In response to receiving a DNS query, malicious domain detection service 176 obtains the domain associated with the DNS query and obtains (e.g., performs) a real time domain classification. In some embodiments, malicious domain detection service 176 obtains the real time domain classification by querying a classifier, such as a local classifier or a classifier exposed by a cloud service, etc. The classifier may implement a machine learning model to predict a domain classification (e.g., a maliciousness of the particular domain). In some embodiments, malicious domain detection service 176 obtains the real time domain classification by querying a mapping of domains to domain classifications. The mapping of domains to domain classifications may be in the form of an allowlist (e.g., a list of benign or non-malicious domains) or a denylist (e.g., a list of malicious domains). The mapping of domains to domain classifications stores a set of historical classifications, such as a classifications that had be previously obtained for past DNS queries handled by DNS resolving service 170, classifications for a predefined set of popular domains (e.g., popular domain classifications that are updated regularly/periodically), classifications for a predefined set of interesting domains (e.g., domains for customers of the security service, etc.).

DNS resolving service 170 uses DNS query handling service 178 to handle DNS queries, such as in accordance with one or more predefined security policies. In some embodiments, DNS query handling service 178 enforces a security policy in response to DNS resolving service 170 (e.g., malicious domain detection service 176) determining that the DNS query is malicious.

Network traffic classification service 138 may comprise an anomaly detector 146 (e.g., configured to detect anomalies in network traffic, file samples obtained by intercepting traffic, DNS traffic, or DNS records, etc.), a decision engine 152 (e.g., configured to predict whether network traffic, intercepted file samples, or whether a DNS record is malicious), domain profiles 156, and/or a similarity detector 144. In some embodiments, network traffic classification service 138 detects malicious network traffic or malware obtained from intercepted network traffic (e.g., by classifying a file sample obtained by a security entity or other network node requesting a maliciousness classification).

Network traffic classification service 138 can determine the classification for network traffic (e.g., a file sample obtained from network traffic, a DNS record, a DNS query, a DNS response, a website content, etc.) based at least in part on querying a classifier(s). The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process.

The classifier(s) may implement one or more machine learning models that may be trained according to a machine learning process. Examples of machine learning processes that can be implemented include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc.

According to various embodiments, security platform 140 may receive a query from a security entity (e.g., inline firewall, such as a next generation firewall) for a real-time or offline classification of a network traffic sample, such as a file.

According to various embodiments, in response to network traffic classification service 138 classifying the network traffic sample, system 100 handles the corresponding network traffic according to a predefined policy (e.g., a security policy). For example, in response to predicting that the network traffic sample corresponds to malicious network traffic (e.g., that the domain associated with the network traffic is a squatting domain), system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated).

According to various embodiments, in response to network traffic classification service 138 classifying the network traffic (e.g., the network traffic sample, or a domain associated with the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains (e.g., domains classified as squatting domains) or having certain characteristics/profiles is to be blocked and network traffic associated with other domains (e.g., domains not deemed to be squatting domains or otherwise malicious) or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed domain for a particular network traffic sample, such as a DNS request or DNS response), security platform 140 (e.g., network traffic classification service 138) sends an indication that network activity (e.g., other network traffic samples) associated with the domain are associated with, or otherwise correspond to, the determined classification. Security platform 140 can provide an indication that network traffic matching the network traffic sample predicted to be malicious (e.g., network traffic matching a domain predicted to be a squatting domain) is to be handled as a malicious network traffic. For example, security platform 140 determines (e.g., computes) a signature or identifier for the network traffic/activity (e.g., a hash or other signature, or identifier for the corresponding network session or domain), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, in response to determining the maliciousness classification for a network traffic sample (e.g., obtaining the predicted maliciousness classification, such as from a classifier), network traffic classification service 138 provides an indication of the maliciousness classification, such as to the applicable security entity (e.g., the security entity that provided the network traffic sample or a security entity mediating network traffic for the session associated with the network traffic sample).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within enterprise network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable. In some embodiments, DNS resolving service 170 is implemented at enterprise DNS server 122 rather than, or in addition to, being implemented at security platform 140.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

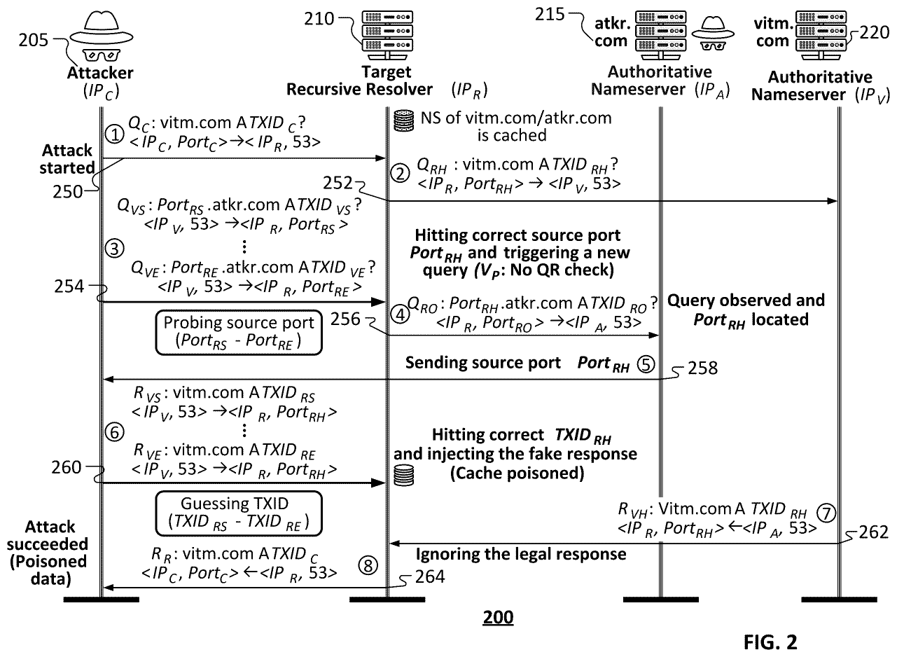

FIG. 2 is a flow diagram of a DNS cache poisoning attempt. In the example shown, process 200 is an example of an attacker 205 performing a DNS cache poisoning using the TuDoor attack. The TuDoor DNS cache poisoning attack is a sophisticated method that exploits vulnerabilities in DNS resolvers by targeting the transaction identification process. Unlike traditional DNS cache poisoning, which often relies on brute force attempts to guess transaction IDs and source ports, the TuDoor attack employs techniques to bypass these defenses by leveraging predictable behaviors in DNS resolver implementations. This makes the attack more effective and harder to detect, particularly against resolvers that lack advanced security measures.

In a TuDoor attack, malicious actors (e.g., attacker 205) manipulate the DNS resolver's (e.g., target recursive resolver 210) behavior by sending carefully crafted DNS queries and responses. The goal is to exploit predictable patterns in how the resolver handles incoming requests and responses. For example, attacker 205 may flood the target recursive resolver 210 with DNS queries for non-existent subdomains of a legitimate domain. This forces the resolver to issue multiple upstream queries to the authoritative server. The attacker then sends spoofed DNS responses that appear to originate from the legitimate server. These responses contain forged information, such as a malicious IP address for the target domain, and are designed to align with the resolver's query, including matching the transaction ID and other fields. In the example shown, at 250, attacker 205 sends to target recursive resolver 210 a DNS query, which at 252, causes target recursive resolver 210 to query authoritative nameserver 220 for DNS information (e.g., a DNS record). At 254, attacker 205 then sends a series of DNS queries to probe the source port of target recursive resolver 210. If one of the DNS queries hits the correct source port for target recursive resolver 210, at 256, the target recursive resolver 210 is triggered to send/forward the corresponding DNS query. Target recursive resolver 210 forwards the DNS query having the correct source port for target recursive resolver 210 to an authoritative nameserver 215 controlled by the attacker. In response to receiving the forwarded DNS query, at 258, the malicious authoritative nameserver 215 sends to attacker 205 an indication of the source port for target recursive resolver 210. In response to obtaining/determining the source port, at 260, attacker 205 uses the determined source port as a source port in a DNS response and sends to target recursive resolver 210 a plurality of spoofed DNS responses to attempt to guess the transaction identifier matching a legitimate existing DNS query. If one of the spoofed DNS responses comprises a legitimate transaction identifier, target recursive resolver 210 is caused to inject the spoofed DNS record to the DNS cache. If later, at 262, target recursive resolver 210 receives a legitimate DNS response for the transaction identifier, ignores (e.g., drops) the legitimate DNS response because it had already received the spoof DNS response and recorded that DNS response. At 264, the target recursive resolver 210 subsequently uses the DNS record from the spoofed DNS response to respond to the DNS query for the particular domain.

What sets TuDoor apart is its ability to evade detection by exploiting specific resolver quirks, such as predictable query timing or improper randomization of source ports. By carefully timing their spoofed DNS responses to coincide with the resolver's queries, attackers increase the likelihood of successfully injecting malicious data into the resolver's DNS cache. Once the DNS cache is poisoned, users relying on the resolver are redirected to malicious destinations, enabling phishing, malware distribution, or other attacks.

According to various embodiments, to detect and mitigate TuDoor DNS cache poisoning attempts, the system employs advanced monitoring and anomaly detection mechanisms. The system continuously observes the behavior of DNS responses, looking for patterns indicative of spoofing attempts. For instance, the system can track a high volume of queries for non-existent subdomains or monitor for an unusual number of invalid or mismatched responses within a short timeframe. These anomalies may signal that an attacker is attempting to flood the DNS resolver with malicious traffic.

According to various embodiments, when a TuDoor-like attack is detected, the system takes active countermeasures to protect the integrity of the DNS cache. These may include temporarily disabling caching for the affected domain, purging suspicious entries from the cache, and alerting network administrators to the attempted attack. By combining real-time monitoring, robust validation, and proactive response strategies, the system provides a comprehensive defense against TuDoor DNS cache poisoning and similar threats.

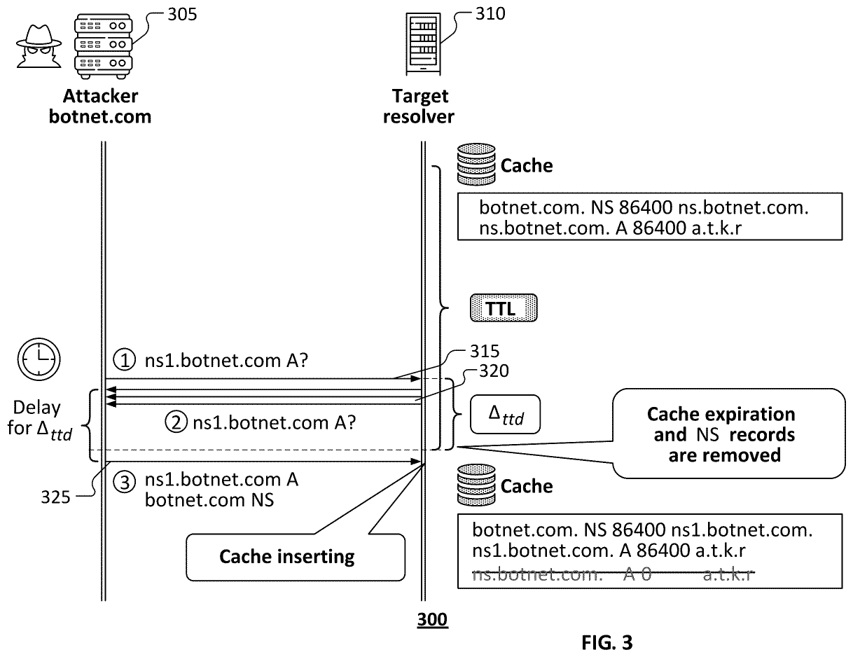

FIG. 3 is a flow diagram of a DNS cache poisoning attempt according to various embodiments. In the example shown, process 300 is an example of an attacker 305 performing a DNS cache poisoning using an attack that exploits the expiration of cached DNS records. At 315, attacker 305 sends a DNS query to target resolver 310. At 320, target resolver 310 provides a DNS response that indicates the expiration of the corresponding DNS record (e.g., the TTL of the DNS record). Attacker 305 waits for the expiration of the DNS record, which has been cached, and then, at 325, promptly sends a spoofed DNS record to target resolver 310 to cause target resolver 310 to insert the spoofed DNS record into the DNS cache, which will then be used to respond to subsequent legitimate DNS queries from victims.

When the system detects a Phoenix Domain T1 attack, it takes immediate countermeasures to protect the DNS cache. These include purging suspicious or incomplete cache entries, temporarily disabling caching for the targeted domain, and notifying network administrators of the attack. The system may also block further queries for affected subdomains until the anomaly is resolved, ensuring that no malicious data is propagated within the network.

By combining robust query monitoring, validation mechanisms, and proactive response strategies, the system provides comprehensive protection against Phoenix Domain T1 DNS cache poisoning and similar sophisticated attacks. This approach ensures the integrity of DNS caches and maintains user trust in the resolution process.

FIG. 4 is a block diagram of a DNS security service for handling DNS queries and detecting or mitigating DNS cache poisoning according to various embodiments. According to various embodiments, system 400 may be implemented at least in part by system 100 of FIG. 1. System 400 may implement processes 500-1600 of FIGS. 5-16.

System 400 comprises a DNS security service 415, which provides DNS security services to a network. DNS security service 415 performs DNS cache poisoning detection. Additionally, or alternatively, DNS security service comprises a real-time detection pipeline that obtains a real time domain classification in connection with detecting DNS traffic associated with malicious domains. DNS security service 415 may further comprise an offline detection pipeline that performs domain classifications offline and stores the domain classifications for use by DNS security service 415 to obtain real time domain classifications. In other embodiments, DNS security service 415 obtains the offline domain classifications from another system or service and caches a mapping of domains to domain classifications for use in handling DNS traffic in real time. Additionally, or alternatively, DNS security service 415 comprises a DNS resolver (or a service that resolves DNS queries).

Although the example shown illustrates DNS security service 415 as distinct/separate from an inline security entity such as firewall 410, in some embodiments, DNS security service 415 may be implemented at the inline security entity.

At 452, firewall 410 obtains a DNS request from a client system 405 (e.g., a customer's systems). Firewall 410 may intercept the DNS request during the handling or mediating traffic to/from the client system 405. In response to obtaining the DNS request, at 454, firewall 410 sends the DNS request to DNS security service 415, such as in connection with querying DNS security service 415 for an indication of whether the DNS request is to be allowed and/or in connection with obtaining a DNS response (e.g., to resolve the DNS request). DNS security service 415 can determine whether the DNS request is to be allowed, such as based on obtaining a real time domain classification. In some embodiments, DNS security service 415 invokes process 500 in connection with detecting DNS traffic (e.g., a DNS request) for a malicious domain.

In some embodiments, DNS security service 415 obtains the real time domain classification based on querying an allowlist, a denylist, or a historical dataset of classified domains. For example, DNS security service 415 queries domain classification cache 425 for a domain classification for the domain associated with the DNS request. The domain classification cache 425 may store domain classifications for previously handled domains, a set of popular domains, and/or a set of interesting domains (e.g., domains associated with customers of the security service). Although the example shows domain classification cache 425 separate from DNS security service 415, in some embodiments, the domain classification cache 425 is part of (e.g., comprised in the DNS security service 415). For example, the domain classification cache 425 may be implemented by the same entity or set of servers as DNS security service 415.

In some embodiments, DNS security service 415 obtains the real time domain classification based on querying a classifier (e.g., a machine learning model) that provides a real time prediction/classification. As an example, the classifier may be part of (e.g., comprised in) DNS security service 415. As another example, the classifier is hosted by a cloud service and exposed to DNS security service 415.

In response to obtaining the domain classification for the domain associated with a DNS request being evaluated/processed by DNS security service 415, DNS security service 415 can handle the DNS request based at least in part on the domain classification. For example, DNS security service 415 can enforce one or more policies, such as a security policy, based on the domain classification. Enforcing a security policy based on the domain classification may include dropping or sinkholing a DNS request for a domain deemed to be malicious. Various other active measures may be implemented. For domains deemed to be benign or non-malicious, DNS security service 415 can proceed to handle the DNS request.

DNS security service 415 may manage DNS cache 420. DNS cache 420 stores a DNS records for a set of domains. The set of domains may include one or more of: (i) domains previously handled by DNS security service 415, (ii) a set of popular domains such as a predefined number of the most popular domains or popular domains provided on a list managed by a third party service, and/or (iii) a set of domains associated with a customer of the DNS security service 415 or domains that are frequently accessed by client systems in the network(s) for which DNS security service 415 provides service. DNS security service 415 can purge DNS records DNS cache 420 when their corresponding TTLs has expired. In some embodiments, DNS security service 415 requests an updated DNS record for those DNS records for which corresponding TTLs have expired or are expected to expire within a threshold period of time. For example, DNS security service 415 resolves the domains and stores the new DNS records in DNS cache 420.

Although the example shows DNS cache 420 separate from DNS security service 415, in some embodiments, the DNS cache 420 is part of (e.g., comprised in the DNS security service 415). For example, DNS cache 420 may be implemented by the same entity or set of servers as DNS security service 415.

In some embodiments, in response to determining to handle the DNS request (e.g., that the domain associated with the DNS request is not malicious), DNS security service 415 resolves the domain in the request based on an ensemble of DNS resolvers. For example, DNS security service 415 implements process 700 to resolve the DNS request. DNS security service 415 determines a set of DNS resolvers (e.g., sub-resolvers) to query in connection with determining a representative DNS response based on the ensemble of DNS resolvers. The set of DNS resolvers may be predefined. The set of DNS resolvers comprises a plurality of DNS resolvers, and at least a subset of the plurality of DNS resolvers are associated with (e.g., located in) a different region(s) or jurisdiction(s). In some embodiments, each of the DNS resolvers in the set of DNS resolvers is associated with a different (e.g., a unique) region or jurisdiction.

DNS security service 415 sends a DNS query to each of the set of DNS resolvers (e.g., the DNS sub-resolvers). In response to receiving DNS responses from each of the set of DNS resolvers or after the lapsing of a predefined period of time, DNS security service 415 determines a representative DNS response (e.g., the legitimate/representative DNS record for the domain) based on an ensemble of the DNS responses received from the set of DNS resolvers. In some embodiments, the system determines the representative DNS response to be the most frequently occurring response (e.g., DNS record comprised in the DNS response) among the ensemble of DNS responses. In some embodiments, the system determines the representative DNS response to be the response (e.g., the DNS record) that appears more than once among the set of DNS responses. In some embodiments, the system determines the representative DNS response to be the response (e.g., the DNS record) comprised in a majority of a set of DNS responses received form a plurality of DNS sub-resolvers.

In the example shown, in response to determining to resolve the DNS request, DNS security service 415 determines to send a DNS query to a set of DNS resolvers, including first DNS server 430, second DNS server 435, and third DNS server 440. As shown, at 456, DNS security service 415 sends the DNS query to first DNS server 430. At 458, DNS security service 415 sends the DNS query to second DNS server 435. At 460, DNS security service 415 sends the DNS query to third DNS server 440.

First DNS server 430, second DNS server 435, and third DNS server 440 resolve the DNS query for the particular domain, such as by recursively querying root DNS servers, TLD servers, and an authoritative DNS servers. At 462, first DNS server 430 provides a DNS response to DNS security service 415. Similarly, at 464, second DNS server 435 provides a DNS response to DNS security service 415. At 455, third DNS server 440 provides a DNS response to DNS security service 415. In response to receiving the DNS responses from first DNS server 430, second DNS server 435, and third DNS server 440, DNS security service 415 determines the DNS response to return to client system 405 (e.g., via firewall 410) in response to the DNS request. For example, DNS security service 415 determines the representative DNS response based on an ensemble or combination of the DNS response received from first DNS server 430, second DNS server 435, and third DNS server 440.

In response to resolving the DNS request (e.g., determining the representative DNS response), at 468, DNS security service 415 provides the representative DNS response to firewall 410. At 470, firewall 410 forwards the representative DNS response to client system 405.

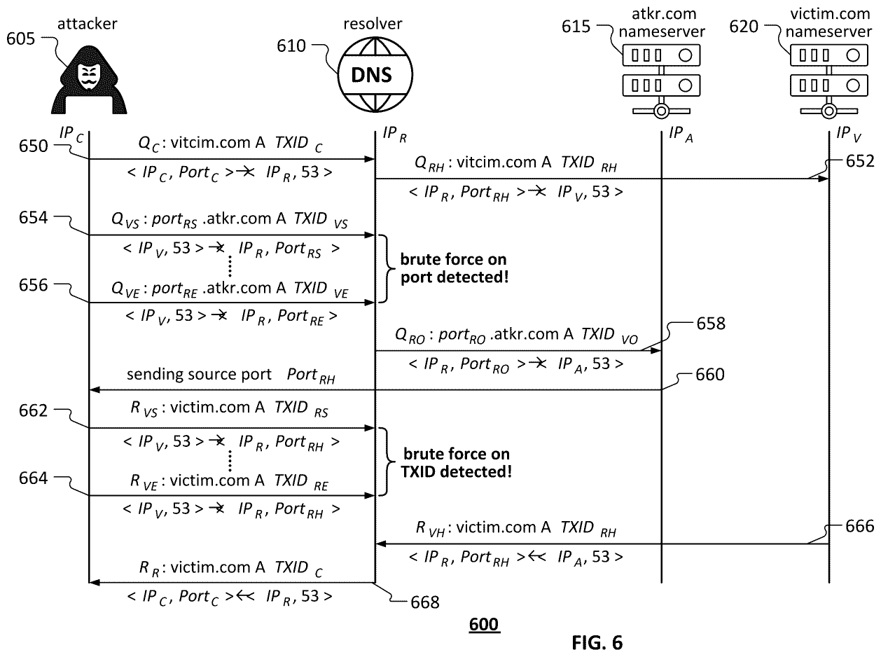

DNS security service 415 provides a DNS cache poisoning detection with respect to DNS cache 420. For example, DNS security service 415 monitors DNS traffic (e.g., DNS responses) and determines whether the DNS traffic is legitimate or non-malicious or whether the DNS traffic is malicious, such as whether DNS traffic corresponds to a DNS cache poisoning attempt. In some embodiments, DNS security service 415 detects DNS cache poisoning based at least in part on a set of DNS responses that are obtained (e.g., collected) over a predefined time period (e.g., the last 1 second, the last 2 seconds, less than five seconds, etc.) for a particular domain. DNS security service 415 can correlate the DNS responses according to the associated domains and evaluate the set of DNS responses for a particular domain. As an illustrative example, system 400 can invoke process 600 of FIG. 6 in connection with detecting DNS cache poisoning.

DNS security service 415 obtains a set of DNS responses received over a predefined period of time for a particular domain. In response to collecting the set of DNS responses for the particular domain, DNS security service 415 determines whether the set of DNS responses are valid. For example, DNS security service determines, for each particular DNS response in the set of DNS responses, whether the particular DNS response is valid. If the number of invalid DNS responses among the set of DNS responses for the particular domain satisfies (e.g., is greater than, or is greater than or equal to, etc.) a predefined invalid DNS response threshold, DNS security service 415 determines that the set of DNS responses correspond to a DNS cache poisoning attack. Conversely, if the predefined invalid response threshold is not satisfied, DNS security service 415 does not conclude that the set of DNS responses are malicious (e.g., correspond to a DNS cache poisoning attack).

DNS security service 415 determines whether a particular DNS response is valid or invalid (e.g., legitimate or illegitimate) based at least in part on information comprised in the particular DNS response and information comprised in an existing DNS query for the domain indicated in the particular DNS response. For example, DNS security service 415 compares information (e.g., critical identifiers) between the existing DNS query and received DNS response and determines that the particular DNS response is invalid if the information comprised in the particular DNS response does not match the information in the corresponding existing DNS query. DNS security service 415 can extract a destination address (e.g., a destination port) and a transaction identifier from the DNS response to be evaluated (e.g., for which the system is to determine whether the DNS response is valid). Similarly, DNS security service 415 obtains the source address (e.g., source port) and transaction identifier extracted from the existing DNS query for the particular domain. If DNS security service 415 determines that the destination address matches (e.g., is the same as) the source address and that the transaction identifiers match (e.g., the transaction identifier from the particular DNS response is the same as the transaction identifier from the DNS query), DNS security service 415 determines the particular DNS response to be valid (or at least not invalid). Conversely, DNS security service 415 determines the particular DNS response to be invalid if either or both of the following are satisfied (i) the destination address does not match the source address, and/or (ii) the transaction identifier from the DNS response does not match the transaction identifier from the existing DNS query for the particular domain.

FIG. 5 is a flow diagram of a method for handling a DNS query according to various embodiments. According to various embodiments, process 500 is implemented at least in part by one or more of system 100 of FIG. 1 and/or system 400 of FIG. 4. In the example shown, DNS resolver 510 receives a DNS query and handles the DNS query according to a domain classification. In some embodiments, DNS resolver 510 may be implemented by DNS resolving service 170 of system 100 and/or DNS security service 415 of system 400. At 550, attacker 505 sends a DNS query to DNS resolver 510. In response to receiving the DNS query, DNS resolver 510 determines the particular domain associated with the DNS query and obtains a domain classification for the particular domain. DNS resolver 510 can obtain the domain classification based at least in part on one or more of (i) querying a local classifier to predict a real time domain classification, (ii) querying a classifier exposed at a cloud security service to predict a real time domain classification, and/or (iii) querying a mapping of domains to domain classifications for a domain classification. The mapping of domains to domain classifications may be an allowlist, a denylist, or a mapping of domains to indications of whether the domains are malicious. In the example shown, DNS resolver 510 determines, based on the domain classification, that the domain is malicious. In response, DNS resolver 510 handles the DNS query based on the domain classification. For example, DNS resolver 510 can enforce a security policy that defines the active measures to be implemented for DNS queries with respect to malicious domains. In the example shown, at 555, DNS resolver 510 responds to the DNS query by sinkholing the DNS query.

FIG. 6 is a flow diagram of a method for detecting a brute force DNS cache poisoning attempt according to various embodiments. According to various embodiments, process 600 is implemented at least in part by one or more of system 100 of FIG. 1 and/or system 400 of FIG. 4. In the example shown, DNS resolver 610 receives DNS traffic and determines whether the DNS traffic is indicative of a DNS cache poisoning attack. In some embodiments, DNS resolver 610 may be implemented by DNS resolving service 170 of system 100 and/or DNS security service 415 of system 400.

In the example shown, at 650, attacker 605 sends to DNS resolver 610 a DNS query, which at 652, causes DNS resolver 610 to query authoritative nameserver 620 for DNS information (e.g., a DNS record). After initiating the DNS query, attacker 605 spoofs a plurality of DNS responses as a brute force attack to predict/guess the correct DNS response information to cause DNS resolver 610 to store a spoofed DNS response in its DNS cache. For example, at 654 and 656, attacker 605 sends a series of spoofed DNS queries with different destination addresses (e.g., destination ports). In the example shown, the DNS queries sent over 654 and 656 have different destination addresses. DNS resolver 610 collects DNS queries for the domain associated with the DNS query received at 650. In some embodiments, DNS resolver 610 determines the set of DNS queries for the particular domain that have been received over a predefined time period (e.g., the last 1 second, the last 2 seconds, etc.). In response to collecting the set of DNS queries for the particular domain, DNS resolver 610 determines whether the set of DNS queries are indicative of a DNS cache poisoning attack. For example, DNS resolver 610, determines whether a number of DNS queries for a particular domain satisfies a predefined threshold (e.g., an invalid DNS query threshold). As another example, DNS resolver 610, determines a number of DNS queries from the of DNS queries having different destination addresses, and determines whether the number of DNS queries collected in the predefined time period for the particular domain that have different destination addresses satisfies a predefined threshold (e.g., the invalid DNS query threshold). Because the number of DNS queries for the particular domain and having different destination addresses exceeds the invalid DNS query threshold, DNS resolver 610 can detect a brute force attack on the port. DNS resolver may enforce a security policy based on detecting the brute force attack on the port, such as by dropping the DNS queries to the particular domain for a certain length of time, alerting an administrator, etc. However, if DNS resolver 610 fails to detect the brute force attack, then if one of the DNS queries hits the correct source port for DNS resolver 610, at 658, the DNS resolver 610 is triggered to send/forward the corresponding DNS query. DNS resolver 610 forwards the DNS query having the correct source port for DNS resolver 610 to an authoritative nameserver 615 controlled by the attacker 605. In response to receiving the forwarded DNS query, at 660, the malicious authoritative nameserver 615 sends to attacker 605 an indication of the source port for DNS resolver 610. In response to obtaining the source port for DNS resolver 610, attacker 605 sends a series of spoofed DNS responses with different combinations of destination addresses (e.g., destination ports) and transaction identifiers. As an example, the different combinations at this stage use the source port for DNS resolver 610 as the destination address, and vary the transaction identifier in attempt to cause a match with a legitimate existing DNS query. In the example shown, the DNS queries sent over 662 and 664 use the same destination address (e.g., the source port obtained at 660) but with different transaction identifiers. DNS resolver 610 collects DNS responses for the domain associated with the DNS query received at 650. For example, DNS resolver 610 determines the set of DNS responses for the particular domain that have been received over a predefined time period (e.g., the last 1 second, the last 2 seconds, etc.). In response to collecting the set of DNS responses for the particular domain, DNS resolver determines whether particular DNS responses in the set of DNS responses are invalid, determines a number of invalid DNS responses among the set of DNS responses, and determines whether the number of invalid DNS responses satisfies a predefined threshold (e.g., an invalid DNS response threshold). Because the number of invalid responses exceeds the invalid DNS response threshold, DNS resolver 610 can detect a brute force attack on the transaction identifier. DNS resolver 610 can detect the DNS cache poisoning attack and enforce a security policy based on the detection. In the example shown, DNS resolver 610 subsequently receives the legitimate DNS response from authoritative nameserver 620. At 668, DNS resolver 610 uses the legitimate DNS response to attacker 605 in response to the DNS query received at 650.

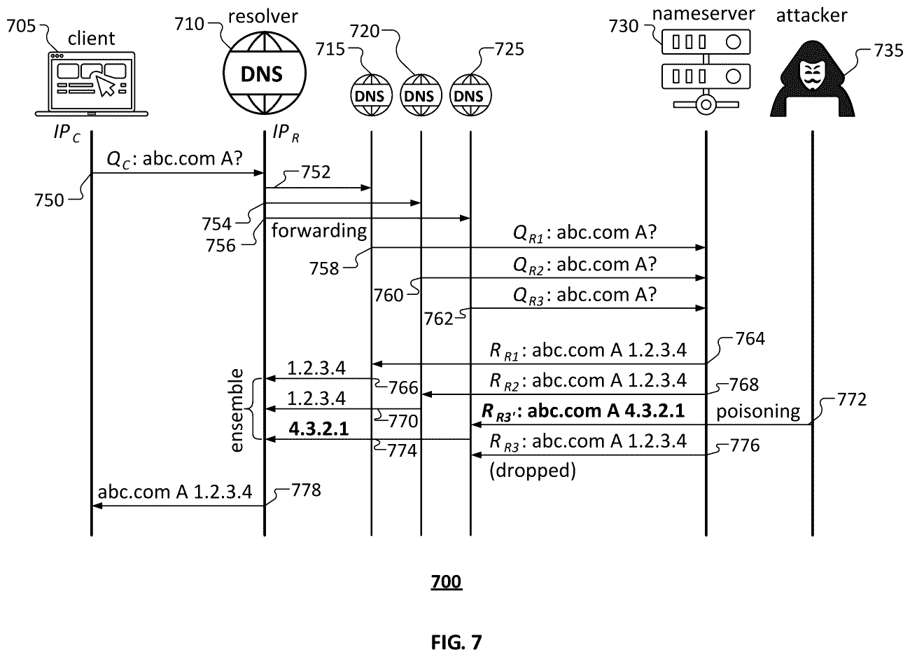

FIG. 7 is a flow diagram of a method for determining a representative DNS response for a DNS query according to various embodiments. According to various embodiments, process 700 is implemented at least in part by one or more of system 100 of FIG. 1 and/or system 400 of FIG. 4. According to various embodiments, process 700 is implemented at least in part by one or more of system 100 of FIG. 1 and/or system 400 of FIG. 4. In the example shown, DNS resolving service 710 receives DNS traffic and handles the DNS traffic in a manner that prevents or mitigates against DNS cache poisoning. In some embodiments, DNS resolving service 710 may be implemented by DNS resolving service 170 of system 100 and/or DNS security service 415 of system 400.

In the example shown, at 750, client 705 sends a DNS query to DNS resolving service 710. For example, the DNS query is intercepted by DNS resolving service 710 implemented on an inline security entity, or the DNS query is intercepted by the inline security entity and forwarded to DNS resolving service 710 by the inline security entity for processing. DNS resolving service 710 is configured to determine DNS responses for a DNS query based on an ensemble of DNS responses obtained by querying a plurality of different DNS resolvers (e.g., DNS sub-resolver 715, DNS sub-resolver 720, and DNS sub-resolver 725). DNS resolving service 710 determines the plurality of DNS resolvers to query in connection with generating a representative DNS response based on an ensemble of DNS responses. For example, at least a subset of the DNS resolvers to be queried service, or are located in, different regions (e.g., and thus may use different nameservers to resolve the domains). In the example shown, in response to receiving the DNS query, at 752, DNS resolving service 710 sends a corresponding DNS query to DNS sub-resolver 715; at 754, DNS resolving service 710 sends a corresponding DNS query to DNS sub-resolver 720; and at 756 DNS resolving service 710 sends a corresponding DNS query to DNS sub-resolver 725. In turn, at 758, DNS sub-resolver 715 resolves the DNS query at least in part by querying nameserver 730; at 760, DNS sub-resolver 720 resolves the DNS query at least in part by querying nameserver 730; and at 762, DNS sub-resolver 725 resolves the DNS query at least in part by querying nameserver 730. At 764, DNS sub-resolver 715 receives a DNS response from nameserver 730, and in turn, at 766, provides (e.g., forwards) the DNS response to DNS resolving service 710. At 768, DNS sub-resolver 720 receives a DNS response from nameserver 730, and in turn, at 770, provides (e.g., forwards) the DNS response to DNS resolving service 710. However, DNS sub-resolver 725 is subject to a DNS cache poisoning attack. Rather than first receiving a legitimate DNS response from nameserver 730, DNS sub-resolver receives a spoofed DNS response from attacker 735 at 772. Because this cache poisoning attempt was successful, at 774, DNS sub-resolver 725 uses the spoofed DNS response to provide the response to DNS resolving service 710. At 776, DNS sub-resolver 725 may subsequently receive the legitimate DNS response from nameserver 730, however, DNS sub-resolver 725 drops this DNS response because it had deemed the spoofed DNS response as legitimate based on the successful DNS cache poisoning attempt. In response to receiving the DNS responses from DNS sub-resolver 715, DNS sub-resolver 720, and DNS sub-resolver 725, DNS resolving service 710 determines a representative DNS response to be used in response to the original DNS query received at 750 (or subsequent DNS queries received for the domain within the TTL of the representative DNS record determined based on the ensemble of DNS responses/records). DNS resolving service 710 can compare the DNS responses received from DNS sub-resolver 715, DNS sub-resolver 720, and DNS sub-resolver 725 and determine that the DNS response (e.g., the DNS record comprised in the DNS response(s)) appearing more frequently (or in some implementations that appear in a plurality of different DNS responses) is the legitimate response (e.g., int eh example shown, the legitimate DNS response being 1.2.3.4). After determining the representative DNS response, at 778, DNS resolving service 710 sends the representative DNS response to client 705 in response to the DNS query received at 750.

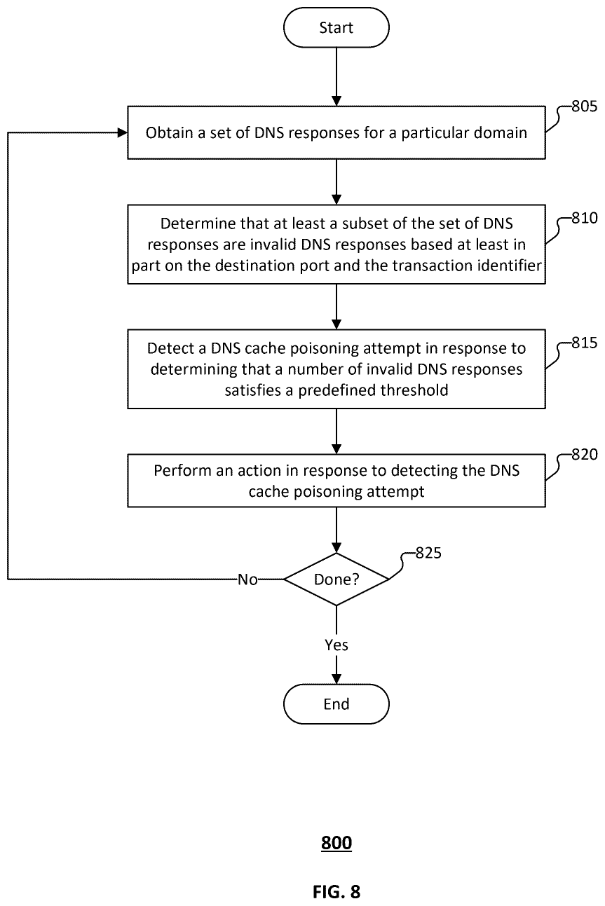

FIG. 8 is a flow diagram of a method for detecting DNS cache poisoning according to various embodiments. According to various embodiments, process 800 is implemented at least in part by one or more of system 100 of FIG. 1 and/or system 400 of FIG. 4.

In some embodiments, process 800 is implemented by a cloud service (e.g., one or more servers) that provides DNS security services and/or other network security services to various network endpoints or security entities. For example, the system may implement process 800 to detect or other mitigate against DNS cache poisoning. As another example, the system may implement process 800 in connection with maintaining a DNS cache with respect to providing DNS services for a network, such as to an inline security entity, etc.

At 805, the system obtains a set of DNS responses for a particular domain. At 810, the system determines that at least a subset of the set of DNS responses are invalid DNS responses based at least in part on the destination port and the transaction identifier. At 815, the system detects a DNS cache poisoning attempt in response to determining that a number of invalid DNS responses satisfies a predefined threshold (e.g., the predefined invalid DNS response threshold). At 820, the system performs an action in response to detecting the DNS cache poisoning attempt. The action can include purging the DNS cache to remove a record/entry corresponding to a DNS cache poisoning attack, alerting a network administrator, alerting a client system from which a DNS query for the domain has originated, etc. At 825, a determination is made as to whether process 800 is complete. In some embodiments, process 800 is determined to be complete in response to a determination that no further samples are to be analyzed (e.g., no further predictions for traffic are needed), no further DNS queries are to be handled, no further DNS responses are obtained or are to be evaluated, an administrator indicates that process 800 is to be paused or stopped, etc. In response to a determination that process 800 is complete, process 800 ends. In response to a determination that process 800 is not complete, process 800 returns to 805.

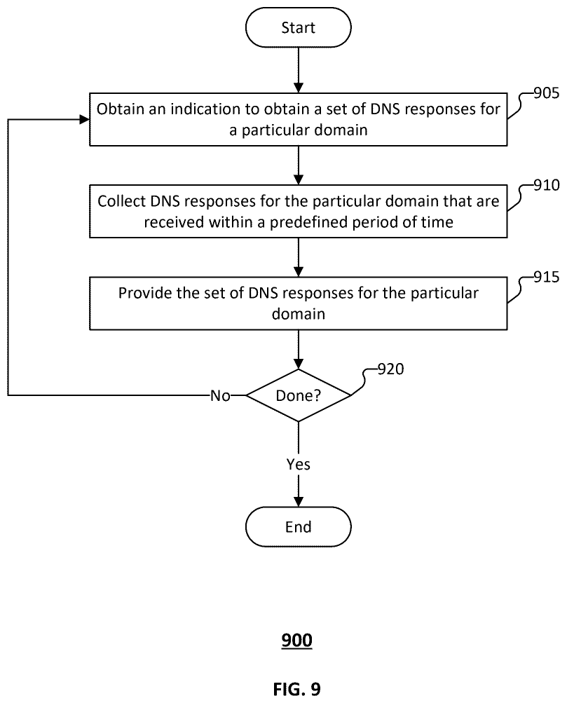

FIG. 9 is a flow diagram of a method for collecting DNS responses in connection with detecting a brute force DNS cache poisoning according to various embodiments. According to various embodiments, process 900 is implemented at least in part by one or more of system 100 of FIG. 1 and/or system 400 of FIG. 4.

In some embodiments, process 900 is implemented by a cloud service (e.g., one or more servers) that provides DNS security services and/or other network security services to various network endpoints or security entities. For example, the system may implement process 900 to detect or other mitigate against DNS cache poisoning. As another example, the system may implement process 900 in connection with maintaining a DNS cache with respect to providing DNS services for a network, such as to a security entity (e.g. an inline security entity) associated with the network, etc.

At 905, the system obtains an indication to obtain a set of DNS responses for a particular domain. At 910, the system collects DNS responses for the particular domain that are received within a predefined period of time. At 915, the system provides the set of DNS responses for the particular domain. At 920, a determination is made as to whether process 900 is complete. In some embodiments, process 900 is determined to be complete in response to a determination that no further entries in a DNS cache are to be evaluated, no further DNS responses are to be obtained, an administrator indicates that process 900 is to be paused or stopped, etc. In response to a determination that process 900 is complete, process 900 ends. In response to a determination that process 900 is not complete, process 900 returns to 905.

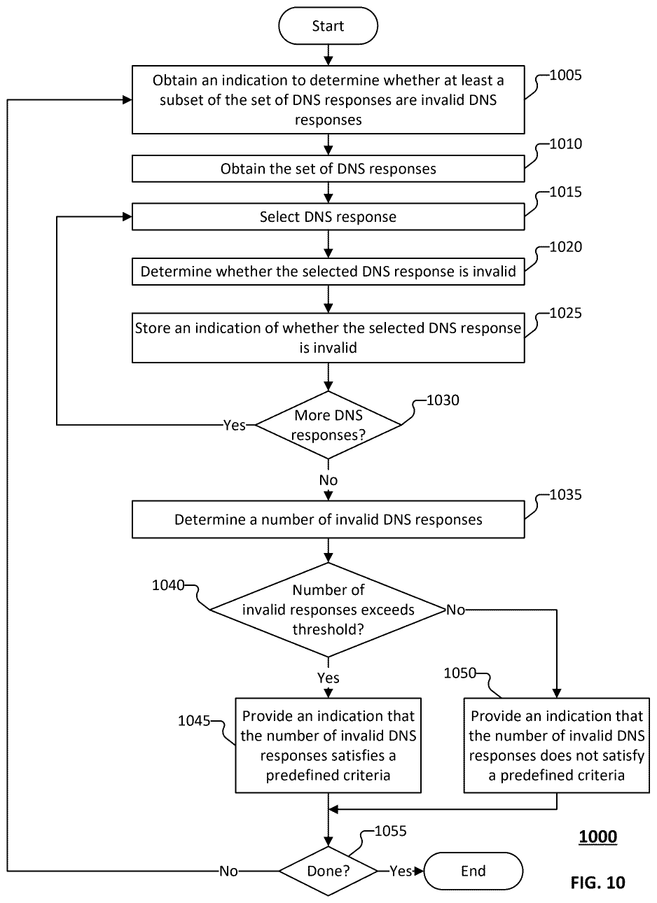

FIG. 10 is a flow diagram of a method for detecting a brute force DNS cache poisoning attempt according to various embodiments. According to various embodiments, process 1100 is implemented at least in part by one or more of system 100 of FIG. 1 and/or system 400 of FIG. 4.

In some embodiments, process 1000 is implemented by a cloud service (e.g., one or more servers) that provides DNS security services and/or other network security services to various network endpoints or security entities. For example, the system may implement process 1000 to detect or other mitigate against DNS cache poisoning. As another example, the system may implement process 1000 in connection with maintaining a DNS cache with respect to providing DNS services for a network, such as to a security entity (e.g. an inline security entity) associated with the network, etc.

At 1005, the system obtains an indication to determine whether at least a subset of the set of DNS responses are invalid DNS responses. At 1010, the system obtains the set of DNS responses. For example, the system obtains a set of DNS responses collected for a particular domain over a predefined period of time (e.g., a most recent threshold period of time, such as DNS responses collected for the domain in the last second, two seconds, five seconds, etc.). At 1015, the system selects a DNS response. At 1020, the system determines whether the selected DNS response is invalid. At 1025, the system stores an indication of whether the selected response is invalid. At 1030, the system determines whether another DNS response(s) is to be evaluated. For example, the system determines whether the set of DNS responses comprises another DNS response that is to be evaluated. In response to determining that the DNS response is to be evaluated, process 1000 returns to 1015 and process 1000 iterates over 1015-1030 until no further DNS responses are to be evaluated. Conversely, in response to determining that no further DNS responses are to be evaluated, process 1000 proceeds to 1035. At 1035, the system determines a number of invalid DNS responses. For example, the system determines the number of DNS responses evaluated through iterations of 1015-1025 that are deemed invalid. At 1040, the system determines whether the number of invalid responses exceeds a predefined threshold. The predefined threshold may be configurable, such as by a network administrator and/or an administrator of a security service for detecting DNS cache poisoning. In response to determining that the system determines that the number of invalid responses exceeds the predefined threshold, process 1000 proceeds to 1045 at which the system provides an indication that the number of invalid DNS responses satisfies a predefined criteria. For example, the system provides the indication that the number of invalid DNS responses satisfies the predefined criteria to another system, service, or process that invoked process 1000, such as 810 or 815 of process 800. Conversely, in response to determining that the system determines that the number of invalid responses does not exceed the predefined threshold, process 1000 proceeds to 1050 at which the system provides an indication that the number of invalid DNS responses does not satisfy a predefined criteria. For example, the system provides the indication that the number of invalid DNS responses does not satisfy the predefined criteria to another system, service, or process that invoked process 1000, such as 810 or 815 of process 800. At 1055, a determination is made as to whether process 1000 is complete. In some embodiments, process 1000 is determined to be complete in response to a determination that no further entries in a DNS cache are to be evaluated, no further DNS responses are to be obtained, an administrator indicates that process 1000 is to be paused or stopped, etc. In response to a determination that process 1000 is complete, process 1000 ends. In response to a determination that process 1000 is not complete, process 1000 returns to 1005.

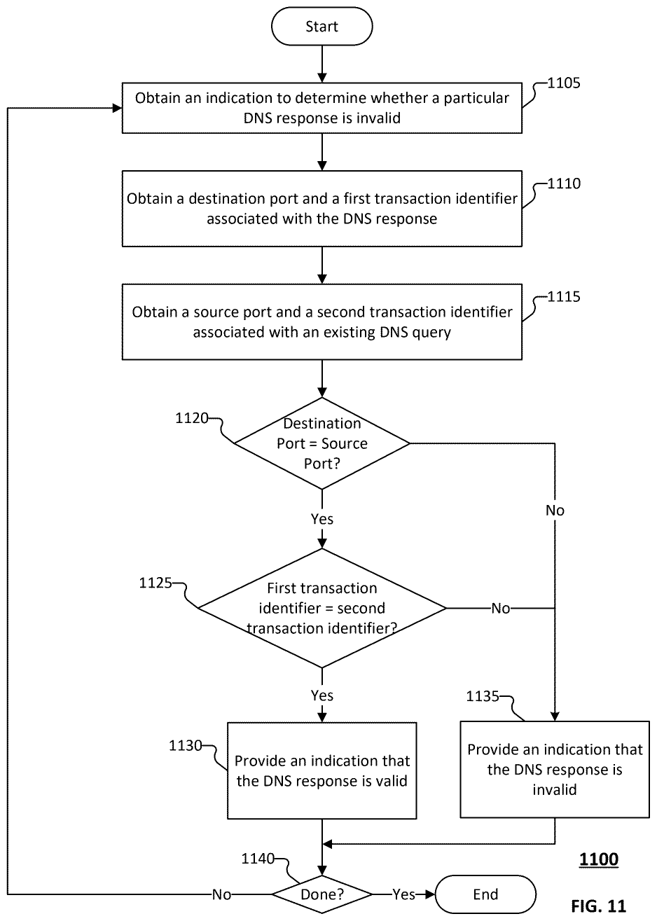

FIG. 11 is a flow diagram of a method for determining whether a DNS response is valid according to various embodiments. According to various embodiments, process 1100 is implemented at least in part by one or more of system 100 of FIG. 1 and/or system 400 of FIG. 4.

In some embodiments, process 1100 is implemented by a cloud service (e.g., one or more servers) that provides DNS security services and/or other network security services to various network endpoints or security entities. For example, the system may implement process 1100 to detect or other mitigate against DNS cache poisoning. As another example, the system may implement process 1100 in connection with maintaining a DNS cache with respect to providing DNS services for a network, such as to a security entity (e.g. an inline security entity) associated with the network, etc.

At 1105, the system obtains an indication to determine whether a particular DNS responses is invalid. At 1110, the system obtains a destination port and a first transaction identifier associated with the DNS response. For example, the system obtains the information pertaining to the particular DNS response being evaluated, etc. At 1115, the system obtains a source port and a second transaction identifier associated with an existing DNS query. For example, the system obtains the information pertaining to an existing DNS query for the particular domain (e.g., the domain for which a DNS cache poisoning classification is being evaluated, etc.). At 1120, the system determines whether the destination port is the same as the source port. For example, the system determines whether the destination port for the DNS response for a particular domain is the same as the source port for the DNS query (e.g., an existing DNS query) for the particular domain. In response to determining that the destination port is the same as the source port, process 1100 proceeds to 1125. Conversely, in response to determining that the destination port is not the same as the source port, process 1100 proceeds to 1135. At 1125, the system determines whether the first transaction identifier is the same as the second transaction identifier. For example, the system determines whether the transaction identifier included in the particular DNS response for a particular domain is the same as the transaction identifier associated with (e.g., comprised) in the DNS query (e.g., an existing DNS query) for the particular domain. In response to determining that the first transaction identifier is not the same as the second transaction identifier, process 1100 proceeds to 1130 at which the system provides an indication that the DNS response is valid. Conversely, in response to determining that the first transaction identifier is not the same as the second transaction identifier, process 1100 proceeds to 1135 at which the system provides an indication that the DNS response is invalid. In some embodiments, the system provides the indication of whether the DNS response is valid to another system, service, or process that invoked process 1000, such as process 800 (e.g., at 810 or 815) or process 1000 (e.g., at 1020), etc. At 1140, a determination is made as to whether process 1100 is complete. In some embodiments, process 1100 is determined to be complete in response to a determination that no further entries in a DNS cache are to be evaluated, no further DNS responses are to be evaluated for a particular domain, an administrator indicates that process 1100 is to be paused or stopped, etc. In response to a determination that process 1100 is complete, process 1100 ends. In response to a determination that process 1100 is not complete, process 1100 returns to 1105.

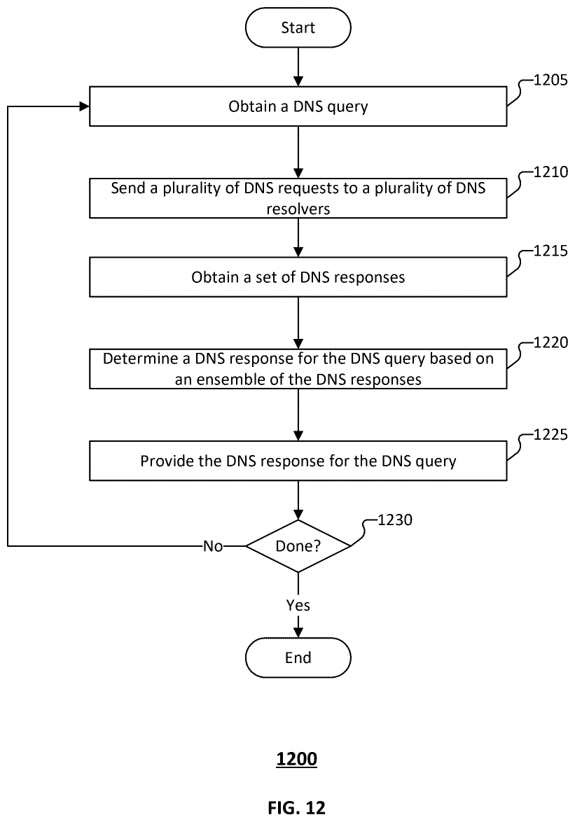

FIG. 12 is a flow diagram of a method for obtaining a DNS response for a DNS query according to various embodiments. According to various embodiments, process 1200 is implemented at least in part by one or more of system 100 of FIG. 1 and/or system 400 of FIG. 4.

In some embodiments, process 1200 is implemented by a cloud service (e.g., one or more servers) that provides DNS security services and/or other network security services to various network endpoints or security entities. For example, the system may implement process 1200 to detect or other mitigate against DNS cache poisoning. As another example, the system may implement process 1200 in connection with providing a DNS service or maintaining a DNS cache with respect to providing DNS services for a network. The system may provide the DNS service or network security service to a security entity, such as an inline security entity, etc. An inline security entity provides to the system an intercepted network traffic sample (e.g., DNS traffic sample such as a DNS query) for a real-time (e.g., near real-time) domain classification and the system implements process 1200 contemporaneous with the security entity's handling of the network traffic.

At 1205, the system obtains a DNS query. At 1210, the system sends a plurality of DNS requests to a plurality of DNS resolvers. For example, the system determines a plurality of different DNS resolvers to query for a DNS record corresponding to a particular domain (e.g., the domain extracted from the DNS query) in connection with determining a representative DNS response from an ensemble of DNS resolvers. At least a subset of the plurality of different DNS resolvers are in different regions or jurisdictions. In some cases, each of the plurality of different DNS resolvers is in a different region or jurisdiction. At 1215, the system obtains a set of DNS responses. For example, the system obtains the set of DNS responses from the plurality of different DNS resolvers. At 1220, the system determines a DNS response for the DNS query based on an ensemble of the DNS responses. At 1225, the system provides the DNS response for the DNS query. At 1230, a determination is made as to whether process 1200 is complete. In some embodiments, process 1200 is determined to be complete in response to a determination that no further DNS queries are to be processed or evaluated, no further network traffic is intercepted or to be evaluated, an administrator indicates that process 1200 is to be paused or stopped, etc. In response to a determination that process 1200 is complete, process 1200 ends. In response to a determination that process 1200 is not complete, process 1200 returns to 1205.

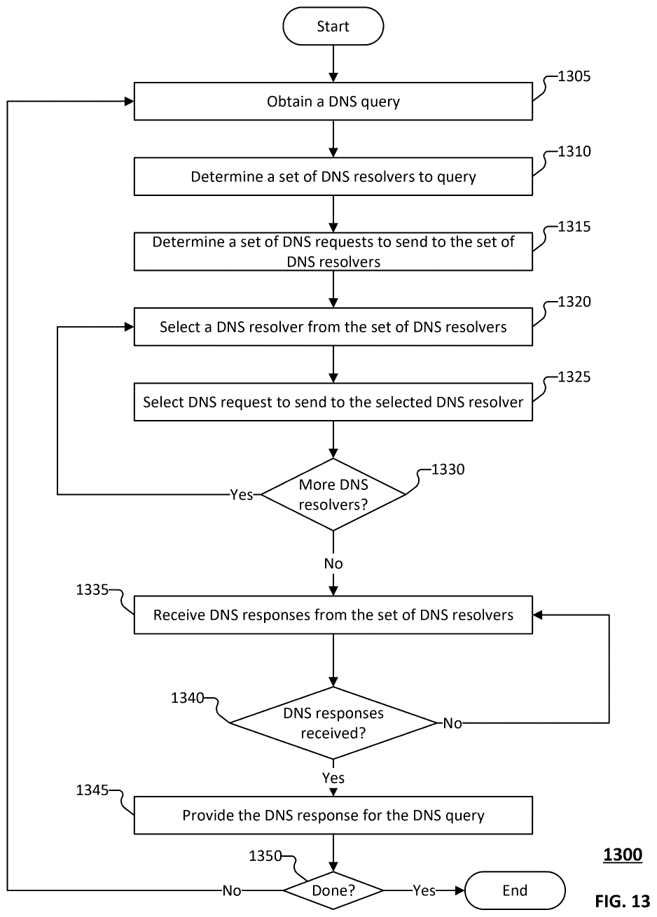

FIG. 13 is a flow diagram of a method for obtaining a DNS response for a DNS query according to various embodiments. According to various embodiments, process 1300 is implemented at least in part by one or more of system 100 of FIG. 1 and/or system 400 of FIG. 4.

In some embodiments, process 1300 is implemented by a cloud service (e.g., one or more servers) that provides a DNS resolving service, DNS security services and/or other network security services to various network endpoints or security entities. For example, the system may implement process 1300 to detect or other mitigate against DNS cache poisoning. As another example, the system may implement process 1300 in connection with providing a DNS service or maintaining a DNS cache with respect to providing DNS services for a network. The system may provide the DNS service or network security service to a security entity, such as an inline security entity, etc. An inline security entity provides to the system an intercepted network traffic sample (e.g., DNS traffic sample such as a DNS query) for a real-time (e.g., near real-time) domain classification and the system implements process 1300 contemporaneous with the security entity's handling of the network traffic.

In some embodiments, process 1300 is implemented in connection with updating a record in a DNS cache, such as when (or anticipation of) the TTL for the DNS record stored in the DNS cache has lapsed.

At 1305, the system obtains a DNS query. The system may receive the DNS query in connection with a request to perform a real-time DNS response, or in connection with updating an entry/record in a DNS cache. At 1310, the system determines a set of DNS resolvers to query for a response for the DNS query. In some embodiments, the set of DNS resolvers includes DNS sub-resolvers that are to be queried in connection with determining a representative DNS response for a DNS query. The representative DNS response may be a DNS response that is generated based on an ensemble of DNS responses provided by a set of DNS resolvers (e.g., a set of DNS sub-resolvers). The set of DNS resolvers may be predefined and/or configurable, such as by a network or system administrator. At 1315, the system determines a set of DNS requests to send to the set of DNS resolvers. At 1320, the system selects a DNS resolver from the set of DNS resolvers. At 1325, the system selects a DNS request to send to the selected DNS resolver. At 1330, the system determines whether a DNS request is to be sent to another DNS resolver. For example, the system determines whether DNS requests have been sent to all DNS resolvers (e.g., DNS sub-resolvers) in the set of DNS resolvers. As another example, the system determines whether all DNS sub-resolvers have been queried for a DNS response that is used to determine (e.g., generate) a representative DNS response for the DNS query. In response to determining that another DNS resolver (e.g., of the set of DNS resolvers) is to be queried, process 1300 returns to 1320 and process 1300 iterates over 1320-1330 until no further DNS resolvers in the set of DNS resolvers is to be queried. Conversely, in response to determining that no further DNS resolvers are to be queried (e.g., that DNS requests have been sent to each DNS resolver in the set of DNS resolvers), process 1300 proceeds to 1335 at which the system receives DNS responses from the set of DNS resolvers. For example, the system receives a set of DNS responses for the set of DNS requests sent to the DNS sub-resolvers. At 1340, the system determines whether all the DNS responses have been received. For example, the system determines whether responses have been received from each DNS resolver in the set of DNS resolvers. In some embodiments, the system deems that all DNS responses have been received after a threshold period of time. For example, the system determines the representative DNS response based on all DNS responses that have been received within the threshold period of time (e.g., after which the remaining DNS requests have timed out). In response to determining that all DNS responses have not been received (e.g., or that the threshold period of time has not lapsed), process 1300 returns to 1345 and process 1300 iterates over 1335-1340 until no further DNS responses are to be received. Conversely, in response to determining that all DNS responses (for the set of DNS requests) have been received (e.g., or that the threshold period of time has lapsed), process 1300 proceeds to 1345. At 1345, the system provides the DNS response for the DNS query. In some embodiments, the system determines a representative DNS response for the DNS query based on the responses received from the set of DNS resolvers for the set of DNS requests. The representative DNS response for the DNS query based on the ensemble of DNS sub-resolvers. In some embodiments, the system provides the DNS response (e.g., the representative DNS response) to the DNS query to another system, service, or process that invoked process 1300 (e.g., at 1225 at process 1200).

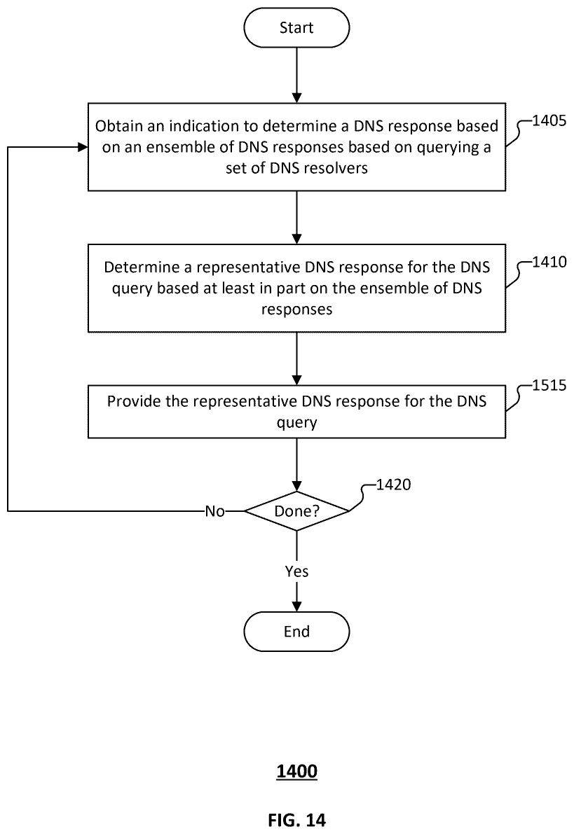

FIG. 14 is a flow diagram of a method for determining a representative DNS response for a DNS query according to various embodiments. According to various embodiments, process 1400 is implemented at least in part by one or more of system 100 of FIG. 1 and/or system 400 of FIG. 4.

In some embodiments, process 1400 is implemented by a cloud service (e.g., one or more servers) that provides a DNS resolving service, DNS security services and/or other network security services to various network endpoints or security entities. For example, the system may implement process 1400 to detect or other mitigate against DNS cache poisoning. As another example, the system may implement process 1400 in connection with providing a DNS service or maintaining a DNS cache with respect to providing DNS services for a network. The system may provide the DNS service or network security service to a security entity, such as an inline security entity, etc. An inline security entity provides to the system an intercepted network traffic sample (e.g., DNS traffic sample such as a DNS query) for a real-time (e.g., near real-time) domain classification and the system implements process 1400 contemporaneous with the security entity's handling of the network traffic.

In some embodiments, process 1400 is invoked by another system, service, or process. For example, process 1400 may be invoked at 1345 of process 1300.

At 1405, the system obtains an indication to determine a DNS response based on an ensemble of DNS responses based on querying a set of DNS resolvers. The use of an ensemble of DNS responses may mitigate a DNS cache poisoning and/or ensure that a record stored in the DNS cache is representative of the actual domain (e.g., a non-malicious domain). At 1410, the system determines a representatives DNS response for the DNS query based at least in part on the ensemble of DNS responses. In some embodiments, the system determines the representative DNS response to be the most frequently occurring response (e.g., DNS record comprised in the DNS response) among the ensemble of DNS responses. In some embodiments, the system determines the representative DNS response to be the response (e.g., the DNS record) that appears more than once among the set of DNS responses. In some embodiments, the system determines the representative DNS response to be the response (e.g., the DNS record) comprised in a majority of a set of DNS responses received form a plurality of DNS sub-resolvers.

At 1415, the system provides the representative DNS response for the DNS query. At 1420, a determination is made as to whether process 1400 is complete. In some embodiments, process 1400 is determined to be complete in response to a determination that no further samples are to be analyzed (e.g., no further predictions for traffic are needed), no further DNS queries are to be handled, no further real time domain classification are to be obtained, no further network traffic is received, an administrator indicates that process 1400 is to be paused or stopped, etc. In response to a determination that process 1400 is complete, process 1400 ends. In response to a determination that process 1400 is not complete, process 1400 returns to 1405.

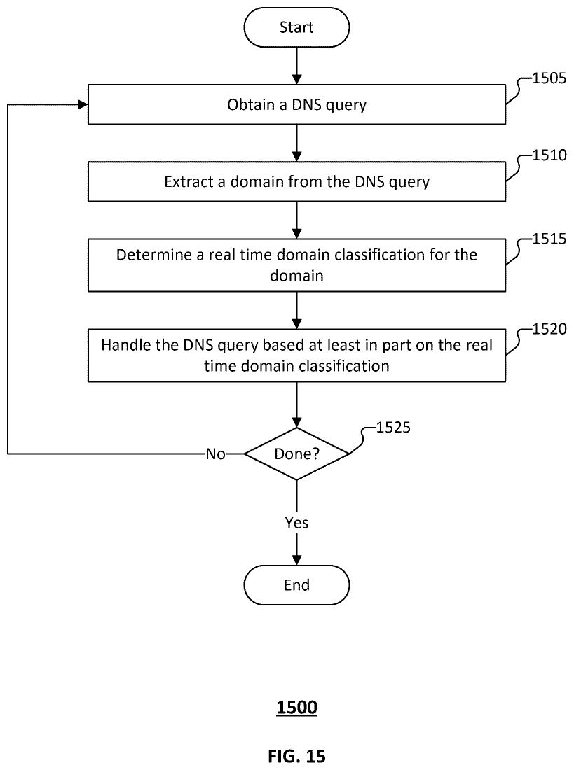

FIG. 15 is a flow diagram of a method for handling a DNS query based on a real time domain classifications according to various embodiments. According to various embodiments, process 1500 is implemented at least in part by one or more of system 100 of FIG. 1 and/or system 400 of FIG. 4.

In some embodiments, process 1500 is implemented by a cloud service (e.g., one or more servers) that provides a DNS resolving service, DNS security services and/or other network security services to various network endpoints or security entities. For example, the system may implement process 1500 to detect or other mitigate against DNS cache poisoning. As another example, the system may implement process 1500 in connection with providing a DNS service or maintaining a DNS cache with respect to providing DNS services for a network. The system may provide the DNS service or network security service to a security entity, such as an inline security entity, etc. An inline security entity provides to the system an intercepted network traffic sample (e.g., DNS traffic sample such as a DNS query) for a real-time (e.g., near real-time) domain classification and the system implements process 1500 contemporaneous with the security entity's handling of the network traffic.

At 1505, the system obtains a DNS query. For example, the system receives the DNS query from a security entity, such as an inline firewall, that has intercepted the DNS traffic. At 1510, the system extracts a domain from the DNS query. At 1515, the system determines a real time domain classification for the domain. In some embodiments, the system determines the real time domain classification for the domain based on querying a real time classifier. As an example, the real time classifier may be a classifier stored locally at the system. As another example, the real time classifier is a classifier provided by (e.g., exposed by) another system or service, such as a cloud service that the system can query for a real time domain classification. In some embodiments, the system determines the real time classification based at least in part on querying a local cache. For example, the system invokes process 1600 in connection with obtaining the real time domain classification (or determining whether a real time domain classification is cached locally). At 1520, the system handles the DNS query based at least in part on the real time domain classification. In some embodiments, the system enforces or applies one or more security policies based on a real time domain classification. For example, the system may apply a security policy that indicates that DNS queries for malicious domains are to be dropped. As another example, the system may apply a security policy that indicates that DNS queries for malicious domains are to be sinkholed. At 1525, a determination is made as to whether process 1500 is complete. In some embodiments, process 1500 is determined to be complete in response to a determination that no further samples are to be analyzed (e.g., no further predictions for traffic are needed), no further DNS queries are to be handled, no further real time domain classification are to be obtained, no further network traffic is received, an administrator indicates that process 1500 is to be paused or stopped, etc. In response to a determination that process 1500 is complete, process 1500 ends. In response to a determination that process 1500 is not complete, process 1500 returns to 1505.

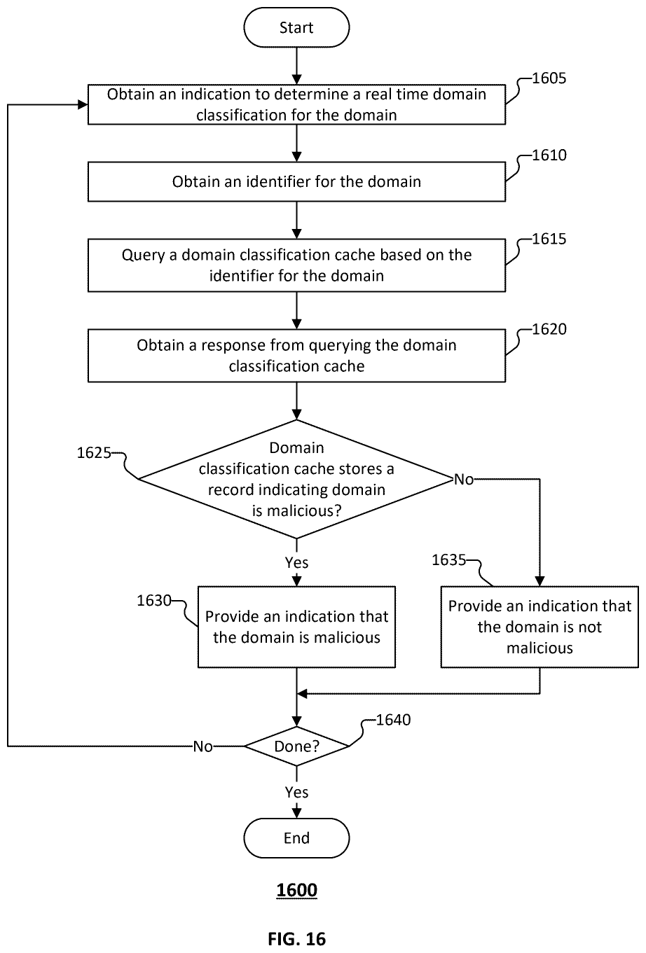

FIG. 16 is a flow diagram of a method for obtaining a real time domain classification according to various embodiments. According to various embodiments, process 1600 is implemented at least in part by one or more of system 100 of FIG. 1 and/or system 400 of FIG. 4.

In some embodiments, process 1600 is implemented by a cloud service (e.g., one or more servers) that provides a DNS resolving service, DNS security services and/or other network security services to various network endpoints or security entities. For example, the system may implement process 1600 to detect or other mitigate against DNS cache poisoning. As another example, the system may implement process 1600 in connection with providing a DNS service or maintaining a DNS cache with respect to providing DNS services for a network. The system may provide the DNS service or network security service to a security entity, such as an inline security entity, etc. An inline security entity provides to the system an intercepted network traffic sample (e.g., DNS traffic sample such as a DNS query) for a real-time (e.g., near real-time) domain classification and the system implements process 1600 contemporaneous with the security entity's handling of the network traffic.

In some embodiments, process 1600 is invoked by process 1500, such as at 1525.

At 1605, the system obtains an indication to determine a real time domain classification for the domain. At 1610, the system obtains an identifier for the domain. At 1615, the system queries a domain classification cache based at least in part on the identifier for the domain. At 1620, the system obtains a response from querying the domain classification cache. At 1625, the system determines whether the domain classification cache stores a record indicating that the domain is malicious. In response to determining that the domain classification cache stores a record indicating that the domain is malicious, process 1600 proceeds to 1630 at which the system provides an indication that the domain is malicious. In response to determining that the domain classification cache does not store a record indicating that the domain is malicious, process 1600 proceeds to 1635 at which the system provides an indication that the domain is not malicious. At 1640, a determination is made as to whether process 1600 is complete. In some embodiments, process 1600 is determined to be complete in response to a determination that no further samples are to be analyzed (e.g., no further predictions for traffic are needed), no further DNS queries are to be handled, no further real time domain classification are to be obtained, no further network traffic is received, an administrator indicates that process 1600 is to be paused or stopped, etc. In response to a determination that process 1600 is complete, process 1600 ends. In response to a determination that process 1600 is not complete, process 1600 returns to 1605.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
obtain a set of domain name system (DNS) responses for a particular domain, wherein each DNS response comprises a destination port and a transaction identifier;
determine that at least a subset of the set of DNS responses are invalid DNS responses based at least in part on the destination port and the transaction identifier;
detect a DNS cache poisoning attempt in response to determining that a number of invalid DNS responses satisfies a predefined threshold; and
perform an action in response to detecting the DNS cache poisoning attempt; and
a memory coupled to the one or more processors and configured to provide the one or more processors with instructions.

2. The system of claim 1, wherein performing the action comprises voiding a DNS cache record for the particular domain.

3. The system of claim 1, wherein performing the action comprises updating a DNS cache record for the particular domain.

4. The system of claim 1, wherein a particular DNS response is deemed invalid in response to a determination that the particular DNS response does not match an existing DNS query.

5. The system of claim 4, wherein:
a first transaction identifier and a destination port extracted from the particular DNS response;
a second transaction identifier and a source port extracted from the existing DNS query; and
the particular DNS response is determined to match the existing DNS query based on a determination that: (i) the first transaction identifier and the second transaction identifier match, and (ii) the destination port and the source port match.

6. The system of claim 1, wherein the set of DNS responses comprise DNS responses received within a predefined period of time.

7. The system of claim 6, wherein the predefined period of time is less than or equal to two seconds.

8. The system of claim 6, wherein the predefined period of time is less than 1 second.

9. The system of claim 6, wherein the predefined period of time is less than 5 seconds.

10. The system of claim 1, wherein in response to determining that a particular DNS response in the set of DNS responses is a valid DNS response, storing information pertaining to the DNS response in a DNS cache of previously visited domain names.

11. The system of claim 7, wherein the DNS cache is local to a service that resolves DNS queries.

12. The system of claim 7, wherein the DNS cache is updated to purge DNS records that are no longer valid.

13. The system of claim 1, wherein the predefined threshold is greater than 50.

14. The system of claim 1, wherein the predefined threshold is greater than or equal to 100.

15. The system of claim 1, wherein the one or more processors are further configured to:
receive a DNS query;
in response to receiving the DNS query,
obtain a domain classification for the domain associated with the DNS query; and
in response to determining that the DNS query is malicious based at least in part on the domain classification, perform an active measure with respect to the DNS query.

16. The system of claim 15, wherein the active measure includes one or more of (i) dropping the DNS query, (ii) sinkholing the DNS query, (iii) alerting a network administrator of the DNS query for a malicious domain, and (iv) alerting a client system from which DNS query was initiated that the domain associated with the DNS query is malicious.

17. The system of claim 15, wherein obtaining the domain classification for the domain associated with the DNS query comprises:
determining whether a domain classification cache comprises a record for a previous domain classification for the domain; and
in response to determining that the domain classification cache comprises the record for the previous domain classification for the domain, obtain the domain classification for the domain based at least in part on the record.

18. The system of claim 17, wherein the domain classification cache is local to a service that resolves DNS queries.

19. The system of claim 15, wherein obtaining the domain classification for the domain associated with the DNS query comprises:
querying a classification service for a real time domain classification; and
obtaining the real time domain classification.

20. The system of claim 19, wherein the classification service is a classifier local to a service that resolves DNS queries.

21. The system of claim 19, wherein the classification service is provided by a cloud security service.

22. The system of claim 1, wherein the one or more processors are further configured to:
receive a DNS query;
in response to receiving the DNS query,
determine a set of DNS requests to send to a set of DNS resolvers, the set of DNS resolvers comprising a plurality of different DNS resolvers;
for each DNS request in the set of DNS requests, send a particular DNS request to a corresponding DNS resolver from the set of DNS resolvers;
receive a set of DNS responses from at least a plurality of DNS resolvers from the set of DNS resolvers;
determine an address for the domain associated with the DNS query based at least in part on the set of DNS responses; and
provide the address for the domain associated with the DNS query.

23. The system of claim 22, wherein at least two of the plurality of DNS resolvers have different corresponding regions.

24. The system of claim 1, wherein the one or more processors are further configured to:
receive a DNS query; and
in response to receiving the DNS query,
determine a DNS query response based on an ensemble of DNS responses obtained from a plurality of different DNS resolvers.

25. A method, comprising:
obtaining a set of domain name system (DNS) responses for a particular domain, wherein each DNS response comprises a destination port and a transaction identifier;
determining that at least a subset of the set of DNS responses are invalid DNS responses based at least in part on the destination port and the transaction identifier;
detecting a DNS cache poisoning attempt in response to determining that a number of invalid DNS responses satisfies a predefined threshold; and
performing an action in response to detecting the DNS cache poisoning attempt.

26. A computer program product embodied in a non-transitory computer readable medium and comprising computer instructions for:
obtaining a set of domain name system (DNS) responses for a particular domain, wherein each DNS response comprises a destination port and a transaction identifier;
determining that at least a subset of the set of DNS responses are invalid DNS responses based at least in part on the destination port and the transaction identifier;
detecting a DNS cache poisoning attempt in response to determining that a number of invalid DNS responses satisfies a predefined threshold; and
performing an action in response to detecting the DNS cache poisoning attempt.

27. A system, comprising:
one or more processors configured to:
receive a domain name system (DNS) query;
determine a set of DNS requests to send to a set of DNS resolvers, the set of DNS resolvers comprising a plurality of different DNS resolvers;
for each DNS request in the set of DNS requests, send a particular DNS request to a corresponding DNS resolver from the set of DNS resolvers;
receive a set of DNS responses from at least a plurality of DNS resolvers from the set of DNS resolvers;
determine an address for the domain associated with the DNS query based at least in part on the set of DNS responses; and
provide the address for the domain associated with the DNS query; and
a memory coupled to the one or more processors and configured to provide the one or more processors with instructions.

28. The system of claim 27, wherein determining the address for the domain associated with the DNS query comprises:
resolving the DNS query based on an ensemble of the DNS responses in the set of DNS responses.

29. The system of claim 27, wherein the address for the domain associated with the DNS query is determined to be a particular address comprised in a plurality of the DNS responses in the set of DNS responses.

30. The system of claim 27, wherein the address for the domain associated with the DNS query is determined to be a particular address that is comprised most frequently among the set of DNS responses.

31. A method, comprising:
receiving a domain name system (DNS) query;
determining a set of DNS requests to send to a set of DNS resolvers, the set of DNS resolvers comprising a plurality of different DNS resolvers;
for each DNS request in the set of DNS requests, sending a particular DNS request to a corresponding DNS resolver from the set of DNS resolvers;
receiving a set of DNS responses from at least a plurality of DNS resolvers from the set of DNS resolvers;
determining an address for the domain associated with the DNS query based at least in part on the set of DNS responses; and
providing the address for the domain associated with the DNS query.

32. A computer program product embodied in a non-transitory computer readable medium and comprising computer instructions for:
receiving a domain name system (DNS) query;
determining a set of DNS requests to send to a set of DNS resolvers, the set of DNS resolvers comprising a plurality of different DNS resolvers;
for each DNS request in the set of DNS requests, sending a particular DNS request to a corresponding DNS resolver from the set of DNS resolvers;
receiving a set of DNS responses from at least a plurality of DNS resolvers from the set of DNS resolvers;
determining an address for the domain associated with the DNS query based at least in part on the set of DNS responses; and
providing the address for the domain associated with the DNS query.
